(19) United States
(12) Patent Application Publication
(10) Pub. No.: US 2008/0008183 A1
(43) Pub. Date: Jan. 10, 2008

(54) Communication Device, Storage Medium, Integrated Circuit, and Communication System

(76) Inventors: Keiichi Takagaki, Osaka (JP); Hiroshi Yokota, Osaka (JP); Takeshi Kokado, Kyoto (JP); Yoshinori Okazaki, Osaka (JP); Salahuddin Muhammad Salim Zabir, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/793,020

(22) PCT Filed: Nov. 22, 2005
(86) PCT No.: PCT/JP05/21410

§ 371 Date: Aug. 29, 2007

(30) Foreign Application Priority Data
Dec. 28, 2004 (JP) 2004-379191

(51) Int. Cl. H04L 12/56

(52) U.S. Cl. 370/392; 370/351

(57) ABSTRACT

It is an object of the present invention to provide a QoS controllable communication device and communication system. A device 114 such as a first IP telephone comprising a QoS control unit 121 of the present invention transmits first transmission control data to a device 111 such as a PC performing lower priority communication. The first transmission control data includes data for changing the communication path of the lower priority communication, and the PC 111, having received the first transmission control data, performs subsequent lower priority communication through the first IP telephone or other device 114, enabling the first QoS control unit 121 to perform priority control. Because the present invention employs widely used protocols such as ARP and ICMP, the device 111 receiving the control data does not need protocols specific to the present invention.

### TECHNICAL FIELD

The present invention relates to a QoS controllable communication device, storage medium, integrated circuit, and communication system.

### BACKGROUND ART

Recently, broadband Internet connections have been widely used in offices and households. FIG. 32 shows a constitution of a typical Internet connection in a household. A user makes a contract with a first ISP (Internet Service Provider) 3, and installs a purchased (or rented from the ISP) first router 12 in a first household 1. To the first router 12, a PC 11 or other device connected to the Internet 2 is connected.

When in this environment the PC 11 communicates with a server 13 open to the Internet, it does so through the first router 12, an access line 6, first ISP 3, and Internet 2. At present, commonly used access lines include ADSL lines (downlink, about 1 Mbps to 50 Mbps; uplink, 512 Kbps to 5 Mbps (see nonpatent document 1: A list of e-access services of ADSL line provides <htpp://www.eaccess.net/service/47miri/index.html>, searched on Sep. 10, 2004.)). Transmission media generally used in household LAN include Ethernet® (100 Mbps both ways). Further, while the first router 12 described herein may when necessary include an ADSL modem function on the Internet side and a hub function on the LAN side (i.e., in the household), it will simply be called a router herein.

Further, applications for real time communications, such as IP telephony and IP videophones, that use the IP (Internet Protocol) used in the Internet, are increasing. Examples include IP Centrex and IP telephony systems for office use, and IP telephony using ADSL, optical fiber or other broadband Internet connection for domestic use.

However, because basically IP has no function for ensuring quality, when real-time communication is to be performed, if communication bandwidth is insufficient, or if there is influence from other communications, the QoS (Quality of Service) may degrade.

For example, in a case where the configuration of FIG. 33 for simple connection of an IP telephony function to the environment of FIG. 32, there is the danger of degraded QoS. The set-up will be explained below.

In FIG. 33, a first IP telephone 14 is connected to the LAN side of the first router 12. With this constitution, when communication is made between the first IP telephone 14 and a second IP telephone 17 included in a separate second household 4, the communication goes through the first router 12, first ISP 3, Internet 2, and second ISP 5 and second router 16 on the side of the second household 4.

When IP telephony communication is to be carried out simultaneously with PC-server communication 31 in an environment as in FIG. 33, both communications are routed through the first router 12 and first ISP 3. An explanation will be made of the processing carried out by the first router 12 at this time, and the degradation of IP telephony QoS due to the phenomena that arise will be described.

FIG. 34 is a schematic drawing showing in detail the internal configuration of the first router 12 of FIG. 33 (only the section relating to data transfer from the LAN side to the access line side). The configuration outside the first household 1 in FIG. 34 is identical to that of FIG. 33.

First, operations in a case where there is only an IP telephone-IP telephone communication 32 will be described. First, the first IP telephone 14 transmits voice data to a LAN line 7 as IP packets. Next, upon receiving these packets, the first router 12 temporarily stores the data in a reception buffer 21. Then, a transmission process unit 22 processes the data at the head of the reception buffer 21 and transmits the same to the access line 6. The amount of voice data transmitted by the first IP telephone 14 is approximately 64 Kbps (in case of ITU-T G. 711), and even when protocol overhead in lower layers is considered, the rate will be less than twice that speed. Therefore, because the ADSL uplink line speed (512 Kbps or higher) is not reached, a large amount of data is not stored in the reception buffer 21, allowing quick transmission of the received data to the access line 6. For this reason, the QoS of the IP telephony communication is ensured.

Next, we will consider the processing by the first router 12 in a case where in addition to the IP telephone-IP telephone communication 32, PC-server communication 31 is simultaneously performed. For example, if the PC-server communication 31 is file transfer, because the PC 11 intends to perform the file transfer at the fastest rate possible, a large amount of data is transmitted to the LAN line 7 at once. The transfer rate of the LAN line 7 (100 Mbps) is extremely fast compared with the uplink line speed (about maximum 5 Mbps) of the ADSL. For this reason, a large amount of data is stored at once in the reception buffer 21 of the first router 12. The transmission process unit 22 transmits the data stored in the reception buffer 21 in order from data at the head to the access line 6. Under such conditions, the following phenomena 1-3 and other phenomena occur.

Phenomenon 1: Delay increases between the time when the IP telephony communication data is stored in the reception buffer 21 and the time when the same is transmitted to the access line 6.

Phenomenon 2: When IP telephony communication data is stored in the reception buffer 21, the amount of data stored in the reception buffer 21 differs depending on timing, causing jitter.

Phenomenon 3: If there is no space available in the reception buffer 21 when the data for the IP telephony communication arrives at the first router 12, IP telephony communication data that arrived is discarded, causing data loss.

When phenomena such as the above occur, the arrival of data lags behind the timing for normal voice generation on the reception side, resulting in a broken speaking voice and degraded voice quality.

Thus, nonpatent document 2 (connection configuration diagram when an IP telephony service Yahoo! BB service is used <htpp://bbpromo.yahoo.co.jp/promotion/service/bbphone/simple_guide/html>, searched on Sep. 10, 2004) discloses a household use IP telephony service configured to prevent degraded IP telephone communication QoS caused by the occurrence of the above phenomena. FIG. 35 shows a configuration for function as an IP telephone (voice data converter 22 etc.) and use of a dedicated router 60 and connection of an analog telephone 70 and the dedicated router 60 using an analog line 73. With such a constitution, the dedicated router 60 performs the following processes, improving the QoS of the IP telephony.

First, analog data from the analog telephone 70 is converted by the voice data converter 25 and used as voice data for the IP telephony communication. The file transfer data from the PC 11 is stored in the reception buffer 23, and the voice data for IP telephony communication converted by the voice data converter 25 is stored in the voice data buffer 24. Next, if voice data is stored in the voice data buffer unit 24, the transmission process unit 22 gives priority to transmitting such data to the access line 6 serving as an ADSL uplink line. On the other hand, the transmission process unit 22 transmits the file transfer data stored in the reception buffer 23 to the access line 6 only if voice data is not stored in the voice data buffer 24. With such a constitution, voice data is not made to stand-by for a long period of time in the voice data buffer 24, and voice data loss is prevented. Thus, the QoS of IP telephony communications is improved.

However, even when the above control is performed, with the occurrence of the following phenomenon 4, the QoS of IP telephony communication may be degraded.

Phenomenon 4: If a voice data packet for IP telephone communication arrives at the voice data buffer 24 while file transfer data is being transmitted to the access line, no voice data packet transmission is performed until the file transfer data transmission is completed. As a result, voice data delay and jitter occur.

A detailed explanation will be given for phenomenon 4 with reference to FIGS. 35 and 36. FIG. 36 is a diagram for explaining timing for transmission of data from a router, and illustrates the timing for arrival of the file transfer data at the router, timing of voice data occurrence, and timing for transmission of data to the access line 6, with the horizontal axis indicating time. We will first consider a state where voice data is not stored in the voice data buffer 24, and only file transfer data is stored in the reception buffer 23. This state occurs, for example, when, in a situation where there is no data in either of the buffers 23 and 24, there is file transfer data arrival 2501 in FIG. 36. According to the above control, first, transmission commences of file transfer data that first arrived at the buffer 23 to the access line 6. As shown in FIG. 36, let us assume that first voice data 2502 arises before the file transfer data transmission ends. By the time file transfer data has been completely transmitted to the access line 6, the first voice data remains stored in the voice data buffer 24. Therefore, there is a first voice data stand-by time 2511. The maximum stand-by time is a value calculated by the following formula: time spent for file transfer data transmission=packet size (bit) of the file transfer data/access line speed. This stand-by time causes delay and jitter, degrading the QoS of the IP telephony communications.

Because file transfer data is generally transferred using TCP (Transmission Control Protocol), the size per packet is often about 1500 bytes. For example, if the access line speed is 512 Kbps, the time for transmitting one packet is about 23 msec. Non patent document 3 (Report IP Network Gijutsu ni Kansuru Kenkyukai, <http://www.soumu.go.jp/s-news/2002/020222_{—}3.html>, searched on Jan. 13, 2005) discusses the quality standards for IP telephony as stipulated by the Ministry of Internal Affairs and Communications. In view of the stipulations therein that, as a standard for Class A communications, where voice quality is to be equivalent to that of a fixed-line phone, the end-to-end delay is to be no more than 100 msec, a delay of 23 msec can be said to cause degradation of the QoS of the IP telephony communications.

To reduce such stand-by time of voice communication data caused by phenomenon 4 and to improve QoS, for example, in patent document 1 (Laid-open Japanese Patent Application No. 2001-53805), a router (device for transferring data for voice communications and PC communications to external networks such as the Internet, corresponding to the dedicated router 60 in FIG. 35) performs IP fragmentation before the PC transfers the communication data to the access line. With such a constitution, file transfer data is fragmented, thereby reducing packet size. Therefore, by interposing voice data between pieces of file transfer data with reduced packet size, voice data stand-by time can be reduced.

Further, patent document 2 (Laid-open Japanese Patent Application No. 2003-60691) discloses a method for securing bandwidth and other network resources prior to starting communication in order to realize QoS control of IP telephony and other real-time communication. With such a constitution, degraded QoS for real-time communication caused by phenomena 1 through 3 can be prevented. In patent document 2, each router for relaying real-time communication comprises a bandwidth management table for managing the correspondence between the routing flow through such router and bandwidth allocated to such flow, and performs bandwidth control based on the bandwidth management table. As used herein, flow includes any flow including real-time communication and non-real-time communication, and is identified by sender address and destination address in the IP header. Further, a separate server is provided for centralized management of bandwidth management tables of the routers, and in response to a request from a communication device to perform real-time communication, the server makes settings in the bandwidth management table of the routers.

### DISCLOSURE OF THE INVENTION

However, in a case where IP telephony service according to nonpatent document 2 or a method described in patent document 1 is used to prevent degraded QoS, because it is necessary that control be performed by a dedicated router into which the output from an analog telephone 70 is input or which has a fragmentation function as described in patent document 1, the constitutional requirement that a dedicated router be installed restricts the freedom of users. Further, in order to use the IP telephony service described in nonpatent document 2, a user needed to subscribe to a specific ISP, and purchase or rent a new dedicated router 60. Therefore, for a user who subscribed to an ISP not having IP telephony service, and thus used an Internet connection configured as in FIG. 32, there was the problem that to use IP telephony, there were initial costs for changing ISPs and then the cost of purchasing a new router. Further, by changing ISPs a user encounters such problems as no longer being to receive services provided only by the prior ISP, such as hosting services and virus check service, and e-mail address being changed.

Further, in order to apply the method for realizing the QoS control described in patent document 2, everything from a router on the Internet to a household router and IP telephone need to work together to perform operation. For this reason, it was unrealistic to change such systems to order to use IP telephony in a household.

Thus, it is an object of the present invention to provide a QoS controllable communication device and a communication system.

With a view toward solving the above problems, according to first aspect of the present invention, A communication device that performs communications via a network in which a plurality of communications with different priority ranking are performed and that controls communications in accordance with the priority rankings, comprising: a priority information holding unit for holding priority information with respect to the priority ranking of each communication; and a path change control unit for generating, based on the priority information, first control data for changing a communication path for lower priority communication, and transmitting the first control data to a lower priority communication device performing the lower priority communication, or to a relay device relaying a lower priority communication performed between other communication devices via the network.

The lower priority communication device that carries out lower priority communication receives first control data for changing the communication path for lower priority communication from a communication device that controls communications in accordance with priority ranking (“communication device that performs priority control”), and changes the communication path based on the first control data. Therefore, when there is congestion between higher priority communication and lower priority communication, the communication path for lower priority communication is changed, giving priority to securing a path for the higher priority communication. Thus, the communication device that performs priority control, in addition to performing a communication function, is capable of controlling communications in accordance with priority ranking. Therefore, by connecting a communication device that performs priority control to a household LAN where communication control in accordance with priority ranking is not carried out, not only is communication performed via a network using a communication device that performs priority control, but the QoS of a higher priority communication is secured. Thus, there is no need to separately provide a dedicated router for performing communication control in accordance with priority ranking to ensure QoS. Therefore, there is no need for a user to change router or system configuration, and a user can carry out high quality real-time communication such as IP telephony using any ISP provider. Further, simply by providing a communication device that performs priority control capable of ensuring QoS, the QoS of a higher priority communication device can be ensured without any change of the overall system, including lower priority communication device, higher priority communication device, and relay device.

Examples of a higher priority communication device that performs higher priority communication include IP telephones that require real-timeness for telephone communication. Examples of a lower priority communication device include terminals for performing, for example, file transfer. Therefore, by using a communication device that carries out priority control to secure the QoS of an IP telephone, real-timeness is maintained.

When the first control data is transmitted to the lower priority communication device, the communication path from the lower priority communication device to the other party communication device is changed. Further, when the first control data is transmitted to the relay device, the communication path from the other party communication device to the lower priority communication device is changed.

A second aspect of the present invention provides a communication device according to the first aspect of the present invention, wherein the path change control unit changes a destination of the communication path for the lower priority communication in the first control data to an undeliverable address.

With the change of a destination of the communication path for lower priority communication to an undeliverable address, the lower priority communication device transmits the transmission data to the undeliverable address. Therefore, because the transmission data transmitted from the lower priority communication device is discarded, even if there is congestion among higher priority communication and lower priority communication, priority is given to securing a communication path for the higher priority communication.

A third aspect of the present invention provides a communication device according to the first aspect of the present invention, wherein the path change control unit changes a destination of the communication path for the lower priority communication in the first control data to an address of the communication device that controls communications in accordance with priority ranking, and further comprises

a communication control unit for controlling output of data transmitted from the lower priority communication device to the network.

With the change of the destination of the communication path for lower priority communication to the communication device that performs priority control, data transmitted from the lower priority communication device is transmitted to the communication device that performs priority control. The communication device that performs priority control makes adjustment so as to control output of transmission data from, for example, a lower priority communication device to a network. With such a constitution, even when there is congestion between higher priority communication and lower priority communication, priority is given to securing a communication path for the higher priority communication.

A fourth aspect of the present invention provides a communication device according to the third aspect of the invention, wherein the communication control unit further comprises:

an analysis unit for analyzing whether its own device is the destination for at least one received data and whether the received data is lower priority communication data from the lower priority device; and

a selection unit for controlling such that, in accordance with the results of analysis by the analysis unit, higher priority communication data is selected over lower priority communication data, the destination of which is a device other than its own device and is transmitted to its destination.

Determination of necessity of relay is made based on whether the destination of the received data is its own device. With the use of such analysis unit and selection unit, even when there is congestion between higher priority communication and lower priority communication, priority is given to securing a communication path for the higher priority communication.

Here, there is further provided a transmission data generator for generating transmission data for transmission to the other party communication device, and when the transmission data is higher priority communication data, selection unit makes selection so as to give priority to transmitting such transmission data. With such a constitution, when the communication device itself is to transmit the higher priority transmission data to another communication device, priority is given to transmitting its own higher priority transmission data over the lower priority communication data requiring relay. Further, selection unit makes selection so as to give priority to transmitting the higher priority communication data from among a plurality of received data. With such a constitution, when the communication device receives a plurality of received data from a plurality of communication devices that require relay to other communication devices, priority is given to transmitting received data having the highest priority from among such received data.

A fifth aspect of the present invention provides a communication device according to the fourth aspect of the invention, wherein the communication control unit further comprises: an adjustment unit for preforming an address rewriting process that, in accordance with the results of analysis by the analysis unit, rewrites the sender address of lower priority communication data for which the destination is a device other than its own device to the address of its own device, and rewrites the destination address of the lower priority communication data to the original destination address of the lower priority communication data transmitted from the lower priority communication device prior to the path change, and the adjustment unit transmits the lower priority communication data after the address rewriting process to the selection unit.

By rewriting addresses a device can function as a network device that performs relay and loopback, allowing suitable relay and loopback of traffic.

A sixth aspect of the present invention provides a communication device according to the fourth aspect of the present invention, further comprising a higher layer process unit that processes received data addressed to its own device in accordance with the results of analysis by the analysis unit, wherein the analysis unit determines whether the received data is addressed to its own device by analyzing the IP header of the received data and determining whether the IP address is of its own device, and if the received data is addressed to its own device, transmits the received data to the higher layer process unit; and if the destination is a device other than its own device, transmits the received data to the selection unit.

IP level analysis is performed on a frame detoured at the Ethernet level, enabling relay and loopback. Further, with respect to a frame that arrived at its own device but is addressed to another device, a priority control device will not have to perform any interruption of other processes, rendering unnecessary extra communications-related processes.

A seventh aspect of the present invention provides a communication device according to the third aspect of the present invention, wherein the communication control unit is constituted by hardware.

Because relay of a frame addressed to other devices and processes relating to priority control can be performed by hardware, priority control can be performed without using an expensive CPU, provided the CPU is used having the necessary capacity to perform transmission/reception of own terminal applications.

An eighth aspect of the present invention provides a communication device according to the fourth aspect of the present invention, wherein the communication control unit further comprises: an adjustment unit for discarding the lower priority communication data in whole or in part, and the adjustment unit transmits to the selection unit the lower priority communication data after it has been discarded in whole or in part.

Because adjustment unit of a communication device that performs priority control discards data transmitted from the lower priority communication device, even when there is congestion between higher priority communication and lower priority communication, priority is given to securing a communication path for the higher priority communication.

A ninth aspect of the present invention provides a communication device according to the fourth aspect of the present invention, wherein the communication control unit further comprises: an adjustment unit for performing a first adjustment process to adjust a communication rate of the lower priority communication, and the adjustment unit transmits to the selection unit the lower priority communication data after the first adjustment process.

With the adjustment of transmission rate of the transmission data received from the lower priority communication device, transmission rate to and from a counterparty communication device for lower priority communication can be adjusted. Therefore, when there is congestion between higher priority communication and lower priority communication, the amount of transmission from a lower priority communication device to its counterparty, and amount of transmission to a lower priority communication device from its counterparty are reduced by adjusting down the transmission rate, and priority is given to securing a communication path for higher priority communication.

A tenth aspect of the present invention provides a communication device according to the ninth aspect of the present invention, wherein the adjustment unit adjusts a transmission rate by adjusting a value in a window field of a TCP header.

With the adjustment of TCP flow control of a lower priority communication device, priority is given to securing a communication path for a higher priority communication.

The 11th aspect of the present invention provides a communication device according to the ninth aspect of the present invention, further comprising a storage unit for storing the lower priority communication data, and if the lower priority communication data is TCP data packets or TCP ACK packets, the adjustment unit stores the lower priority communication data for a certain period of time using storage unit, and thereafter transmits the same to the selection unit.

With the adjustment of TCP flow control of the lower priority communication device, priority is given to securing a communication path for a higher priority communication.

A 12th aspect of the present invention provides a communication device according to the fourth aspect of the present invention, wherein the communication control unit further comprises: an adjustment unit for dividing data transmitted from the lower priority communication device into a plurality of data using a first dividing method, and the adjustment unit transmits the plurality of data divided using the first dividing method to the selection unit.

Adjustment unit of a communication device that performs priority control divides data transmitted from a lower priority communication device, thereby preventing a situation where higher priority communication data arrives during lower priority communication data transfer and is caused to wait for a long time. Therefore, the QoS of higher communication is improved.

A 13th aspect of the present invention provides a communication device according to the 12th aspect of the present invention, wherein the first dividing method makes division into IP fragments.

Because the IP fragmentation reception function is a function that an ordinary IP communication device has, higher priority communication QoS is improved without requiring that other devices have a special function.

A 14th aspect of the present invention provides a communication device according to the fourth aspect of the present invention, wherein the communication control unit further comprises: adjustment unit for generating, based on communication data received from the lower priority communication device, third control data for controlling the size of communication data from the lower priority communication device to its counterparty communication device or of communication data to the lower priority communication device from its counterparty communication device, and transmitting the same to the lower priority communication device or the communication device of its counterparty.

Further, based on communication data received from the counterparty communication device of the lower priority communication device, adjustment unit may generate fourth control data for controlling the size of communication data from the lower priority communication device to its counterparty communication device and transmit the same to the lower priority communication device.

With such a constitution, with the adjustment of the transmission rate from the lower priority communication device to the counterparty communication device and of the size of the data transmitted from the counterparty communication device to the lower priority communication device, a situation is prevented where higher priority communication data that arrived at the communication device during transfer of the lower priority communication data transfer is caused to wait for a long time, improving higher priority communication QoS.

A 15th aspect of the present invention provides a communication device according to the 14th aspect of the present invention, wherein the third control data is a TCP SYN packet, and the adjustment unit generates a SYN packet by changing the MSS value contained in the received SYN packet to a desired value.

Changing an MSS value enables reduction of size of transmission data. Such an MSS adjustment function in a SYN packet using an MSS option is a function that an ordinary IP communication device has. For this reason, higher priority communication QoS is improved without requiring that other devices have a special function.

A 16th aspect of the present invention provides a communication device according to the 14th aspect of the present invention, wherein the third control data is ICMP Destination Unreachable Fragmentation Needed packets, and the adjustment unit generates ICMP Destination Unreachable Fragmentation Needed packets that contain a portion of the data contained in packets previously transmitted from the lower priority communication device and contain a desired MTU value.

A lower priority communication device that has received a Destination Unreachable Fragmentation Needed packet determines subsequent packet size based on the MTU value contained in the received packet. Adjustment unit of a higher priority communication device changes the MTU value of a lower priority communication device to reduce the size of the data transmitted from the lower priority communication device. Because such an MTU adjustment function at time of receiving an ICMP Destination Unreachable Fragmentation Needed packet is a function that an ordinary IP communication device has, higher priority communication QoS is improved without requiring that other devices have a special function.

A 17th aspect of the present invention provides a communication device according to the first aspect of the present invention, wherein the path change control unit changes, in the first control data, the destination of the communication path for lower priority communication to the address of its own device, and generates second control data for changing the communication path for higher priority communication based on the priority information, and changes the destination for the communication path for higher priority communication in the second control data to the address of its own device, and then transmits the second control data to the higher priority communication device.

By receiving communication both from a lower priority communication device and a higher priority communication device, a communication device that performs priority control can accurately learn the state of congestion between higher priority communication and lower priority communication. Thus, based on the learned congestion state and priority information, if there is congestion, priority is given to outputting data from the higher priority communication device over data from the lower priority communication data. Therefore, priority is given to securing the communication path of the communication path for higher priority communication.

The 18th aspect of the present invention provides a communication device according to the first aspect of the present invention, wherein the first control data transmitted by the path change control unit is any one of an ARP request packet, ARP response packet, ICMP redirect packet or ICMPv6 Neighbor Discovery packet.

A mechanism for ARP request and ARP response is installed in most IP-compatible devices. Therefore, first control data for changing the communication path for lower priority communication can be generated by using the existing ARP request and ARP response. Similarly, a system for ICMP path change is installed in most IP-compatible devices. Further, a system for ICMPv6 Neighbor Discovery packets is installed in most IPv6 devices. Therefore, by using existing mechanisms, when there is congestion between higher priority communication and lower priority communication, priority can be given to securing a communication path for higher priority communication.

A 19th aspect of the present invention provides a communication device according to the first aspect of the present invention, further comprising: a detection unit for detecting whether a communication is being performed by the higher priority communication device via a network, and only when communication is being performed by the higher priority communication device, the path change control unit transmits the first control data to the lower priority communication device or the relay device.

Because a communication path for lower priority communication is changed depending on whether higher priority communication exists, the communication path for higher priority communication can be secured only when necessary, eliminating influence on lower priority communication during other times.

A 20th aspect of the present invention provides a communication device according to the 19th aspect of the present invention further comprising: a QoS value maintaining unit for maintaining a QoS value set for maintaining the quality of higher priority communication, wherein the detection unit further calculates a value for indicating the quality of a higher priority communication and compares the calculated value for indicating the quality with the QoS value, and if the calculated value for indicating the quality is smaller than the QoS value, the path change control unit transmits the first control data to the lower priority communication device or the relay device.

Because the communication path for lower priority communication is changed in accordance with degradation of higher priority communication quality, the communication path for higher priority communication is secured only when necessary, eliminating the influence on lower priority communications during other times.

A 21st aspect of the present invention provides a computer readable recording medium having recorded thereon a priority control program to be executed by a control device that controls communications of a plurality of communications with different priority ranking performed via a network in accordance with the priority rankings so as to cause a computer to function as: a priority information holding unit for holding priority information with respect to the priority ranking of each communication; and a path change control unit for generating, based on the priority information, first control data for changing a communication path for lower priority communication, and transmitting the first control data to a lower priority communication device performing the lower priority communication, or a relay device relaying lower priority communication performed between other communication devices via the network. By using a recording medium in which a priority control program is written, effects identical to those of the first aspect of the present invention can be demonstrated.

A 22nd aspect of the present invention provides an integrated circuit that controls communications in a network in which a plurality of communications with different priority ranking are performed in accordance with the priority rankings, comprising: a priority information holding unit for holding priority information with respect to the priority ranking of each communication; and a path change control unit for generating, based on the priority information, first control data for changing communication path for lower priority communication, and transmitting the first control data to a lower priority communication device performing the lower priority communication, or a relay device relaying a lower priority communication performed between other communication devices via the network. The above integrated circuit demonstrates effects identical to those of the first aspect of the present invention.

A 23rd aspect of the present invention provides a communication system in which a communication device that controls communications in accordance with priority ranking of communications is connected to a plurality of communication devices with different priority ranking, wherein the communication device that controls communications in accordance with priority ranking includes: a priority information holding unit for holding priority information with respect to the priority ranking of each communication; and a path change control unit for generating, based on the priority information, first control data for changing a communication path for lower priority communication having lower priority, and transmitting the first control data to a lower priority communication device performing the lower priority communication, or a relay device for relaying a lower priority communication performed between other communication devices via the network; and the lower priority communication device or the relay device relaying lower priority communications with other communication devices performed via the network receives the first control data from the communication device that controls communications in accordance with the priority ranking to change the communication path for lower priority communication. The above communication system demonstrates effects identical to those of the first aspect of the present invention.

According to the present invention, with the change of a communication path for lower priority communication, control can be performed so as to give priority to a higher priority communication that requires high QoS such as, for example, a real-time communication, securing the communication quality thereof.

### BRIEF DESCRIPTIONS OF THE DRAWINGS

FIG. 1 is a diagram of a network constitution according to the first embodiment;

FIG. 2 is a block diagram of a QoS controller and first IP telephone according to the first embodiment;

FIG. 3 shows data format of an ARP request and ARP response;

FIG. 4 is a data flow of a QoS control process when an ARP request is used;

FIG. 5 shows processing and data flow of a QoS control process when an ARP request is used;

FIG. 6 is a QoS control process flow of a path change control unit when an ARP request is used;

FIG. 7A shows an ARP table (1) of devices subject to control;

FIG. 7B shows an ARP table (2) of devices subject to control;

FIG. 7C shows an ARP table (3) of devices subject to control;

FIG. 8 shows a list of IP/MAC addresses of each device;

FIG. 9 shows installation positions of communication devices of the present invention, and a communication flow after path change control when the communication devices of the present invention are independent LAN terminals;

FIG. 10 shows a QoS controller;

FIG. 11 shows a format of a Neighbor Solicitation packet and Neighbor Advertisement packet;

FIG. 12 shows a format of an ICMP redirect packet;

FIG. 13 shows data flow of a QoS control process when an ICMP redirect packet is used;

FIG. 14 shows processing and data flow of a QoS control process when an ICMP redirect packet is used;

FIG. 15A shows a routing table (1) of devices subject to control;

FIG. 15B shows a routing table (2) of devices subject to control;

FIG. 16 shows a diagram of a network constitution according to the second embodiment;

FIG. 17 shows a block diagram of a QoS control unit and IP telephone according to the second embodiment;

FIG. 18 shows processing and data flow when detailed control is performed after path change control;

FIG. 19 shows an ARP table of devices subject to control;

FIG. 20 shows a routing table of devices subject to control;

FIG. 21 shows an Ethernet® frame and IP packet format;

FIG. 22 is a flowchart of the receiving process in a lower priority communication packet relay process;

FIG. 23 is a flowchart of the transmission process in a lower priority communication packet relay process;

FIG. 24 shows detailed operations of a packet relay process (in a case of a full duplex and buffered communication);

FIG. 25 shows detailed operations of a packet relay process (in a case of a full duplex and non-buffered communication);

FIG. 26 shows detailed operations of a packet relay process (in case of a half duplex communication);

FIG. 27 shows processing and data flow when IP fragmentation is performed in detailed control after path change control;

FIG. 28 shows a format of a TCP SYN packet with an MSS option;

FIG. 29 shows processing and data flow when an MSS value of a TCP SYN packet is changed in detailed control after path change control;

FIG. 30 shows a format of an ICMP Destination Unreachable Fragmentation Needed packet;

FIG. 31 shows processing and data flow when an ICMP Destination Unreachable Fragmentation Needed packet is transmitted in detailed control after path change control;

FIG. 32 is a diagram of a network constitution of a current household LAN (without IP telephone);

FIG. 33 is a diagram of a network constitution when an IP telephone is added to the network of FIG. 27;

FIG. 34 is an internal structural diagram of the router of FIG. 28;

FIG. 35 shows a diagram of network constitution and internal structure of a router according to the prior art; and

FIG. 36 is a diagram for explaining a phenomenon such that when the lower priority communication packet size is large, higher priority communication data is made to stand by.

### BEST MODE TO CARRY OUT THE INVENTION

### First Embodiment

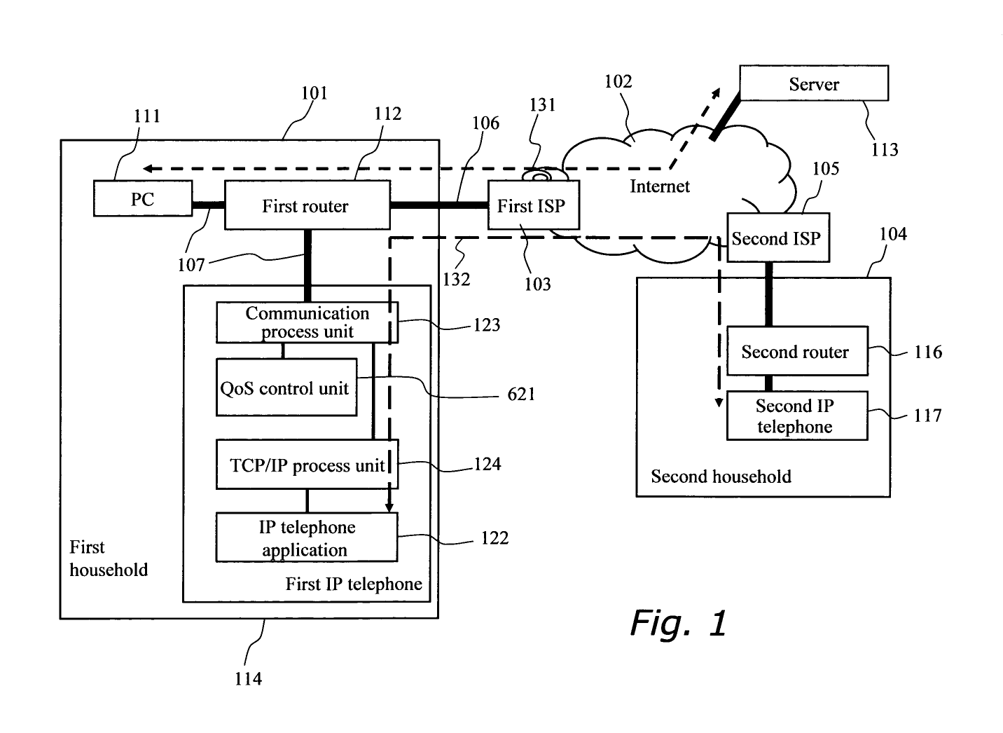

The first embodiment of the present invention will be explained with reference to the drawings. FIG. 1 is a diagram of a network constitution relating to the first embodiment. In FIG. 1, communication devices such as a PC 111 and first IP telephone 114 are connected to the LAN side of a first router 112 included in a first household 101, forming a household LAN. Further, this household LAN is connected to an Internet 102 via an access line 106 and first ISP 103. Further, there is a second router 116 in a second household 104, and a second IP telephone 117 is connected to the LAN side thereof. The household LAN of this second household 104 is connected to the Internet 102 via a second ISP 105.

Further, in FIG. 1, a file transfer 131 (hereinafter, “PC-server communication 131”) is performed between the PC 111 in the first household 101 and a server 113 on the Internet 102, and an IP telephone communication 132 using the Internet 102 (hereinafter, “IP telephone-IP telephone communication 132”) is performed between a first IP telephone 114 in the first household 101 and a second IP telephone 117 in the second household 104. The IP telephone-IP telephone communication 132 requires real-time properties, and is a higher priority communication. On the other hand, the PC-server communication 131 is a lower priority communication. Further, the first IP telephone 114 is a higher priority communication device and the PC 111 is a lower priority communication device.

Further, in FIG. 1, a QoS control unit 621 is provided as a functional part of the first IP telephone 114, and this QoS control unit 621 controls QoS.

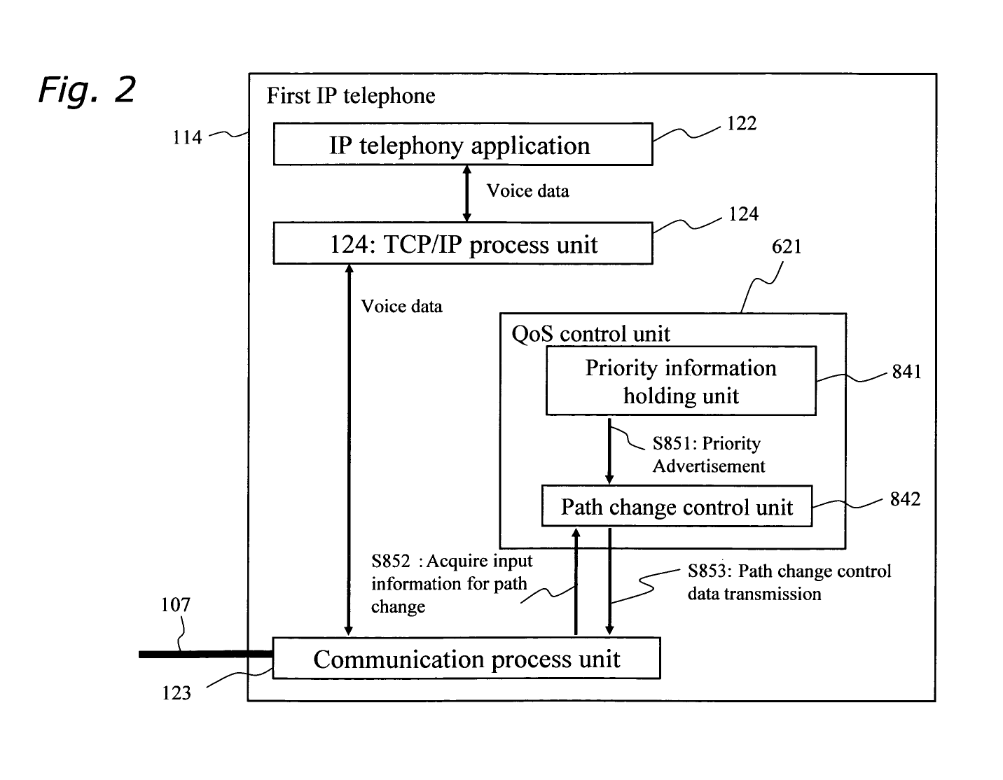

A more detailed explanation will be given with reference to FIG. 2 for the internal configuration of the first IP telephone 114 and QoS control unit 621 of FIG. 1. FIG. 2 is an internal configurational diagram of the first IP telephone 114 and QoS control unit 621. As shown in FIG. 2, the QoS control unit 621 includes a priority information holding unit 841 and path change control unit 842. The priority information holding unit 841 holds priority information relating to communication priority. Priority information is information for distinguishing a higher priority communication from others. The path change control unit 842 generates path change control data for changing communication path for lower priority communication, and transmits path change control data to the PC 111 performing lower priority communication or a relay device that relays a lower priority communication performed between other communication devices via a network. Further, the path change control unit 842 is capable of receiving data from the LAN line 107 via the communication process unit 123 in the first IP telephone 114 and transmitting data to the LAN line 107. Further, an IP telephony application 122 in the first IP telephone 114 receives user voice input, generates voice data for IP telephony communication, and makes transmission to the LAN line 107 via a TCP/IP process unit 124 and communication process unit 123.

We will discuss the process under which the first IP telephone 114 as a communication device of the first embodiment changes the path for lower priority communication (PC-server communication 131 in FIG. 1), thereby interrupting the lower priority communication and ensuring QoS of a higher priority communication (IP telephone-IP telephone communication 132 in FIG. 1).

First, the QoS control process will be explained by outlining its overall flow. Next, QoS control process will be explained in detail.

<Overall Flow of the QoS Control Process>

The QoS control process according to the first embodiment of the present invention is generally performed as follows.

Let us assume that prior to performance of the QoS control process, only lower priority communication (PC-server communication 131) is being performed in the network of FIG. 1. When a higher priority communication (IP telephone-IP telephone communication 132) starts, the following control is performed by the QoS control unit 621. An explanation will be given with reference to FIG. 2.

(1) Process 1

The priority information holding unit 841 holds priority information for distinguishing lower priority communication from higher priority communication, and gives notice of the same to the path change control unit 842 (S851). The first IP telephone 114 is set as a higher priority communication device that performs a higher priority communication, and the PC 111 is set as a lower priority communication device that performs a lower priority communication.

(2) Process 2

The path change control unit 842 acquires information required for generating path change control data to change a path such as an IP address (S852). The information acquired by the path change control unit 842 varies depending on path change method.

The path change control unit 842 generates path change control data for path change from the information acquired in this process and information acquired in process 1, and transmits the path change control data to a device subject to the path change control, or the PC 111 at which the lower priority communication terminates (S853).

The communication process unit 123 transmits the path change control data to the LAN line 107. The path change control data includes information relating to destination after change of data output from the PC 111 as a lower priority communication device. In the present embodiment, as post-change destination, an address not included in the LAN, for example, an IP address or MAC address, is designated.

(3) Process 3

The PC 111 as a lower priority communication device and a device subject to control receives path change control data, and changes communication path for subsequent lower priority communication data.

(4) Process 4

After the communication path is changed in the process 3, the PC 111 transmits the data to a non-existent address. Thus, the lower priority communication is interrupted until the communication path is restored to original state by some process. More specifically, the data from the PC 111 generated in the lower priority PC-server communication 131 is transmitted to a router other than a first router 112, thus interrupting the lower priority communication. As a result, the first router 112 receives only voice data from the first IP telephone 114 generated in the higher priority IP telephone-IP telephone communication 132. For this reason, no congestion occurs between the higher priority communication and lower priority communication in the first router 112. With such a constitution, if there is congestion between a higher priority communication and lower priority communication, the communication path for the lower priority communication is changed, thereby giving priority to securing a communication path for higher priority communication and securing higher priority communication QoS. By connecting a communication device having a function such as QoS control process to a household LAN or the like where communication control in accordance with priority is not performed, communication is carried out via a network using the communication device having a QoS control function, while at the same time ensuring higher priority communication QoS. For this reason, because the communication device ensures QoS, there is no need to separately provide a dedicated router that controls communications in accordance with priority. Therefore, a user does not need to change the configuration of an existing router or system, and can subscribe to any provider, and can still can carry out high quality real-time communications such as IP telephony. Further, simply by providing the first IP telephone 114 capable of ensuring QoS, higher priority communication QoS can be ensured without having to change an overall system that includes the PC 111 as a lower priority communication device and router.

It is not necessary that a lower priority communication be underway before performing the present process. Even in a case where a lower priority communication has started after a higher priority communication, after the present process is performed, the lower priority communication is interrupted, and higher priority communication QoS is ensured.

<Detailed Process of the QoS Control Process>

Next, a detailed description will be given for processes 1-4 of <Overall Flow of the QoS control process> when the above processes are implemented. There are several methods for changing a path; here, an ARP request will be used. This method can be applied only when the communication process unit 123 operates in accordance with Ethernet® protocols.

First, to enable understanding of the processes to be explained below, ARP (Address Resolution Protocol) will be explained. ARP is a protocol for causing devices in a LAN to notify each other of the correspondence between IP address and MAC address (address unique to network interface hardware) in an Ethernet®. When IP communications are to be performed on the Ethernet®, each device transmits an ARP request (designating an IP address of communication counterparty) as a broadcast Ethernet® frame normally about once every 5 minutes, and a device that received the frame, if the designated IP address is its own address, sends back an ARP response as a unicast Ethernet® frame.

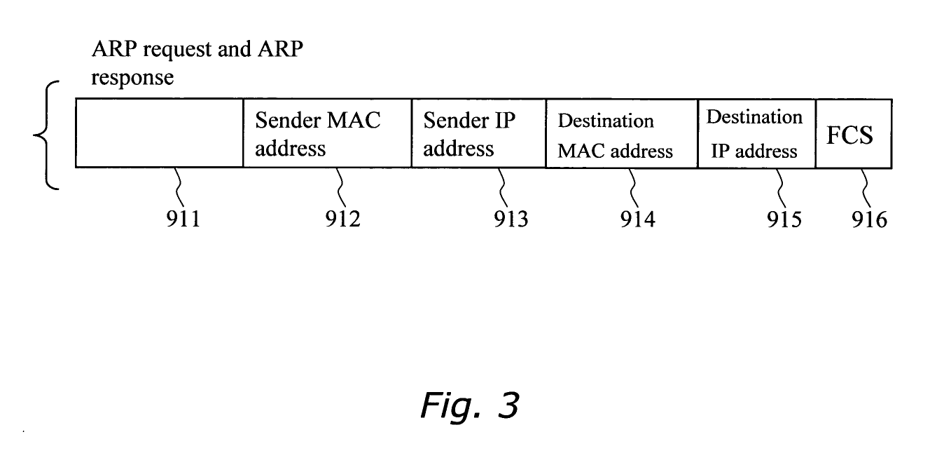

FIG. 3 is a protocol format for an ARP request and ARP response as defined by the RFC 826. A field 911 includes various fields (not shown) such as a field indicating whether such data is an ARP request or ARP response. Further, the ARP request and ARP response include such information as sender MAC address 912 and sender IP address 913 of the sender communication device, and the destination MAC address 914 and destination IP address 915 of the counterparty communication device. For this reason, by receipt of an ARP request or ARP response, sender and destination devices can learn the MAC address corresponding to each other's IP address. Correspondence between IP address and MAC address exchanged by mutual communication is maintained in an ARP table that each communication device has. When transmitting a packet, a communication device searches the ARP table based on the destination IP address of the packet to be transmitted, and determines the destination MAC address of the frame to be transmitted. The FCS (Frame Check Sequence) 916 is information provided for checking damage to the Ethernet® frame.

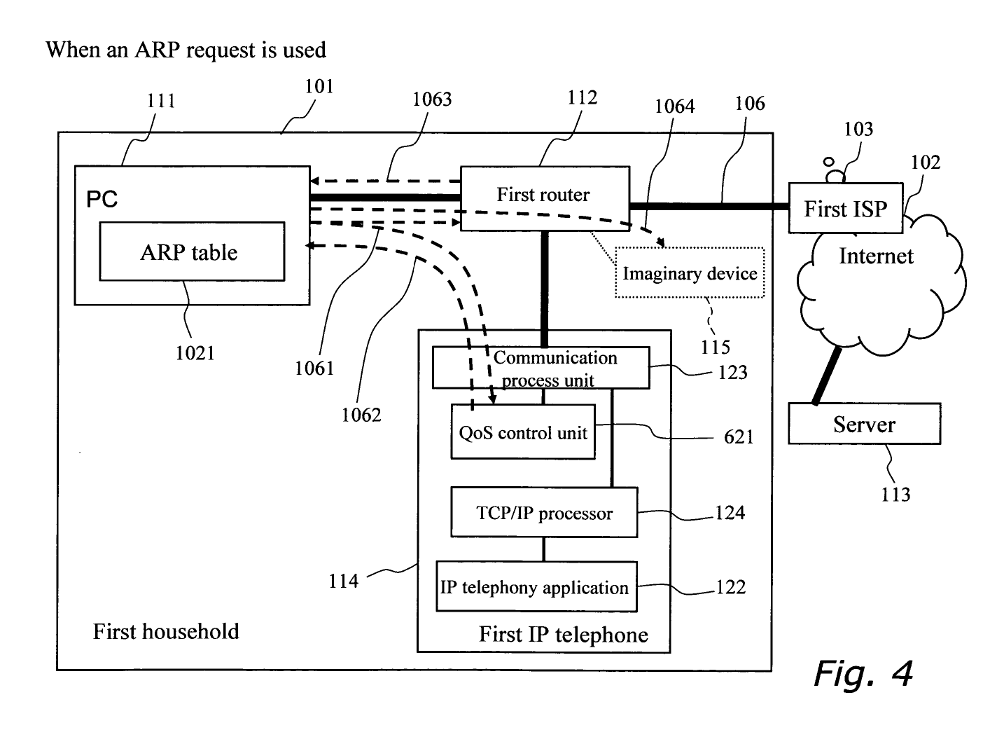

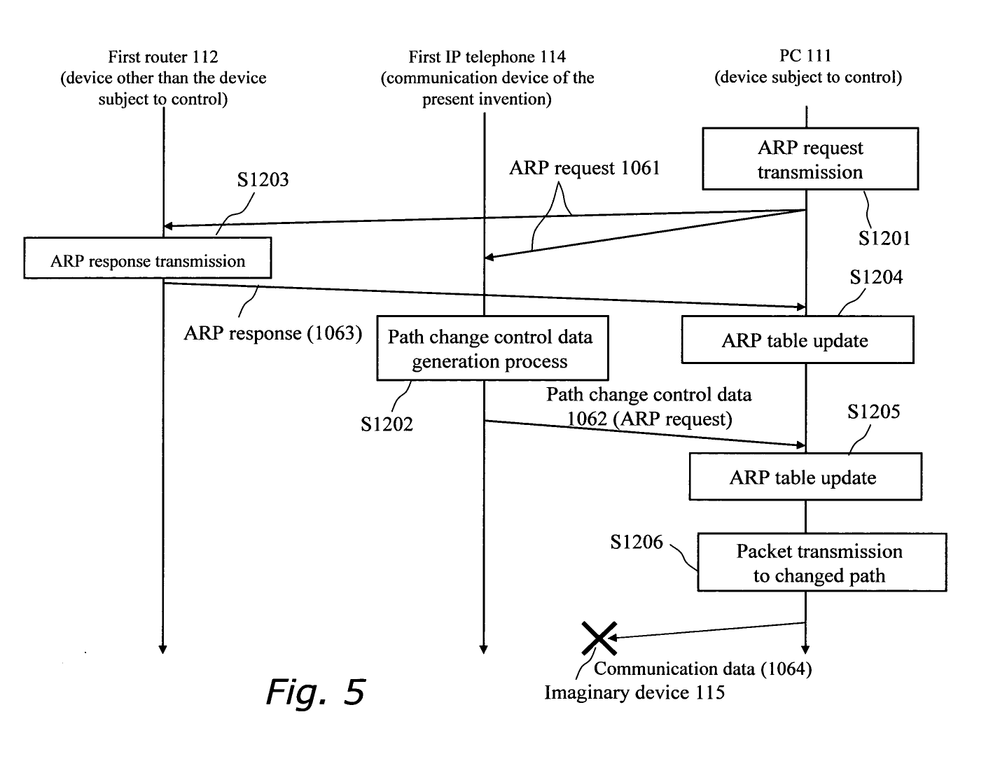

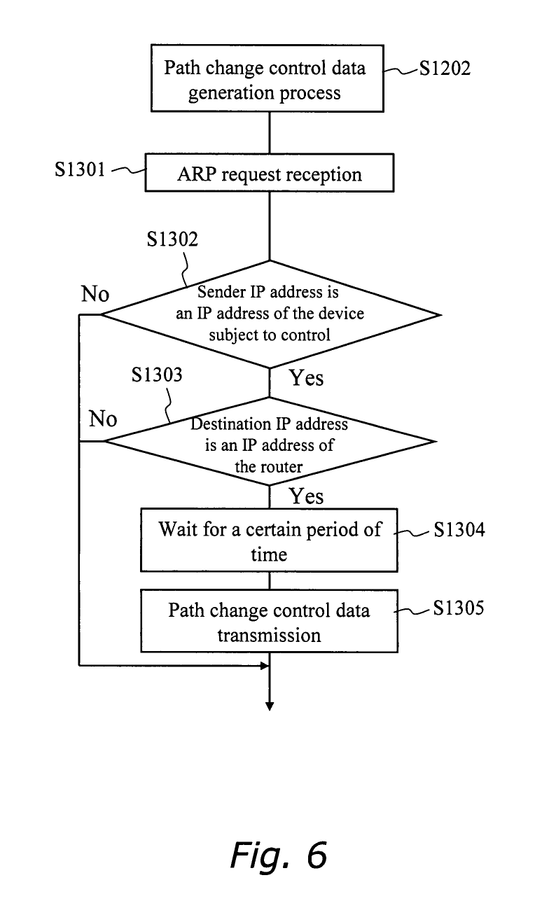

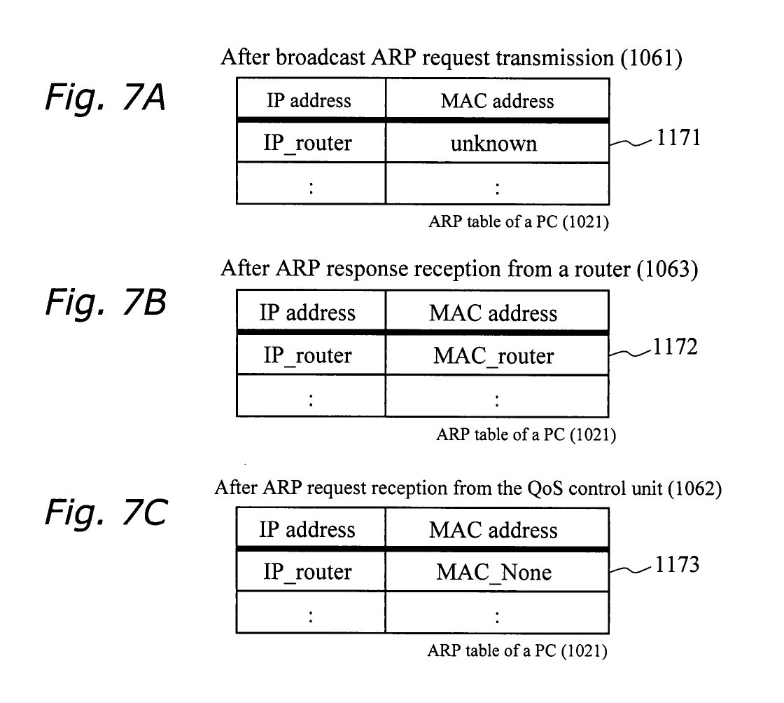

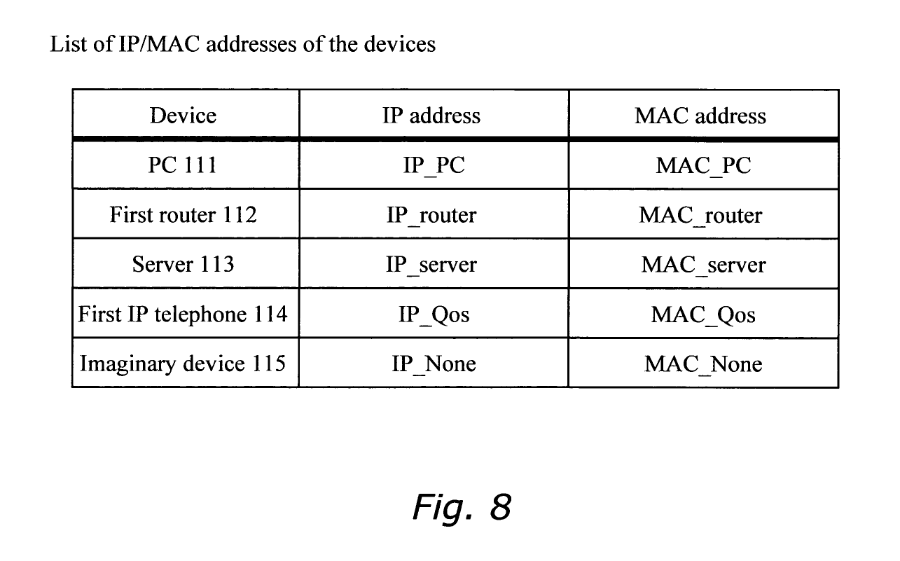

A detailed explanation will be given with reference to FIGS. 1-8 for each of the above QoS control processes 1-4 when an ARP request is used. FIG. 4 is a schematic drawing showing a frame format of the overall data flow in the QoS control process when an ARP request is used, and showing how each data 1061, 1062, 1063 to be handled is moved in the network. FIG. 5 shows an example of the overall process and data flow of the QoS control process when an ARP request is used, and shows in time series the handling of data in the QoS control process and a path change control data generation process in the first IP telephone 114. FIG. 6 shows an example of a path change control data generation process by the path change control unit when an ARP request is used, and FIGS. 7A-7C are examples of an ARP table 1021 of a PC 11 as a device subject to control, and show how the ARP table 1021 is updated as needed in the following processes. FIG. 8 is a list of the IP and MAC addresses of each device, showing the MAC and IP addresses of the PC 111, first router 112, server 113, and first IP telephone 114, and defining an address not included in the LAN as well as an address of an imaginary device 115.

(1) Process 1

Process 1 will be explained with reference to FIG. 2. First, in the present embodiment, we will assume that the IP telephony communication performed by the first IP telephone 114 as an own device is a higher priority communication, all other communications from inside the LAN toward the Internet 2 via the first router 112 are lower priority communications, and the QoS control unit 621 of the present invention is operating. At this time, the priority information holding unit 841 of FIG. 2 has, as default information, an IP_router value necessary for path change control by ARP request. IP_router is an IP address of the first router 112 that relays communications from the PC 111 and first IP telephone 114 to the network 2 as shown in FIG. 8. As an alternative to default information, this information may be input from a user interface, or acquired in some process using the network.

Next, the priority information holding unit 841 gives notice of the IP_router to the path change control unit 842 as information relating to a lower priority communication (see FIG. 2, S851). At the same time, in Step S1302 (described below), to check whether an IP address is that of the PC 111, notice of IP-PC may be given.

(2) Process 2

Explanations will be given for processes 2 and thereafter with reference to FIGS. 4-8.

Step S1201: Next, the PC 111 that is a device in the LAN at which a lower priority communication terminates, as shown in S1201 in FIG. 5, transmits a broadcast ARP request 1061 with the IP_router that is the IP address of the first router 112 initially routed through to communicate with the server 113 as the destination IP address 915. At this time, the ARP table of the PC 111 is a table 1171 of FIG. 7A.

Thereafter, the path change control unit 842 in the QoS control unit performs the path change control data generation process of S1202. Details of this process will be explained with reference to the flowchart in FIG. 6, data 1061, 1062 in FIG. 5, and the block diagram in FIG. 2. ARP request/response fields are as shown in FIG. 3.

(Processes in S1202)

Step S1301: First, the path change control unit 842, as shown in S1301 in FIG. 6, receives an ARP request 1061 (1061 in FIG. 5) from the PC 111 via the communication process unit 123. Thus input information for a path change process in S852 of FIG. 2 is received.

Step S1302: Next, the path change control unit 842 checks whether the sender IP address of the ARP request 1061 received from the PC 111 is the IP address of a device subject to control. Because the first IP telephone 114 is a higher priority communication device and communication devices other than the first IP telephone 114 that perform communications via the first router 112 are lower priority communication devices, check is performed as to whether the sender IP address is an address other than the IP_router address. The sender IP address 913 of the PC 111 as sender of the ARP request 1061 is the IP-PC shown in FIG. 8, thus satisfying condition.

Steps S1303-S1305: Next, the path change control unit 842 checks whether the destination IP address 915 of the ARP request 1061 from the PC 111 is IP_router (S1303). Because the destination IP address 915 of the ARP request 1061 is IP_router, there is a set period of stand-by time (S1304). Thereafter, the path change control unit 842 generates path change control data that is a unicast ARP request 1062 as shown in FIG. 5, and transmits the same via the communication process unit 123 to the PC 111, which is a device subject to control (S1305). The destination IP address 915 and sender address 913 designated here are those substituted with the destination IP address 915 and sender IP address 913 of the received ARP request 1061. Further, in the sender MAC address 912, a MAC-None serving as a MAC address of the imaginary device 115 shown in FIG. 4 is set. The MAC address of the imaginary device 115 can be any MAC address provided that it differs from the MAC addresses of the devices included in the LAN.

Steps S1203, S1204: An explanation will be given for the processes other than the path change control data generation process (S1202) again with reference to FIG. 5. While the first IP telephone 114 awaits for a certain time during the path change control data generation process (S1202), the first router 112 transmits a normal ARP response 1063 in response to the received ARP request 1061 (S1203). The ARP table of the PC 111 that received the above is updated as shown in the table 1172 of FIG. 7B (S1207).

When the path change control unit 842 receives a broadcast ARP request from a device other than a device subject to control, for example, the first router 112 (not shown in the drawings), in Step S1302 in the above path change control data (S1202), check is performed as to whether the sender IP address is a device subject to control (S1302). However, the priority information holding unit 841 needs to give advance notice of the IP address of the device subject to control to the path change control unit 842. In this case, the path change control unit 842 of the first IP telephone 114 generates no path change control data and gives no response, preventing the path of the data transmitted from the first router 112 from being changed.

(3) Process 3

Step S1205: The PC 111 that is a device subject to control, having received the path change control data 1062, updates the ARP table based on the path change control data 1062 (S1205). The ARP table at this time is in the state of the table 1173 of FIG. 7C, in which MAC-None, serving as a MAC address not included in the LAN, is registered as the MAC address corresponding to IP_router.

The reason for waiting for a set period of time (S1304 of FIG. 6) is that, without this step, data will arrive at the PC 111 in the order of the path change control data 1062 and ARP response 1063 from the router, causing the ARP table 1021 of the PC 111 to become as the table 1172 of FIG. 7B in the end, with the result that it may be possible that the path cannot be changed.

(4) Process 4

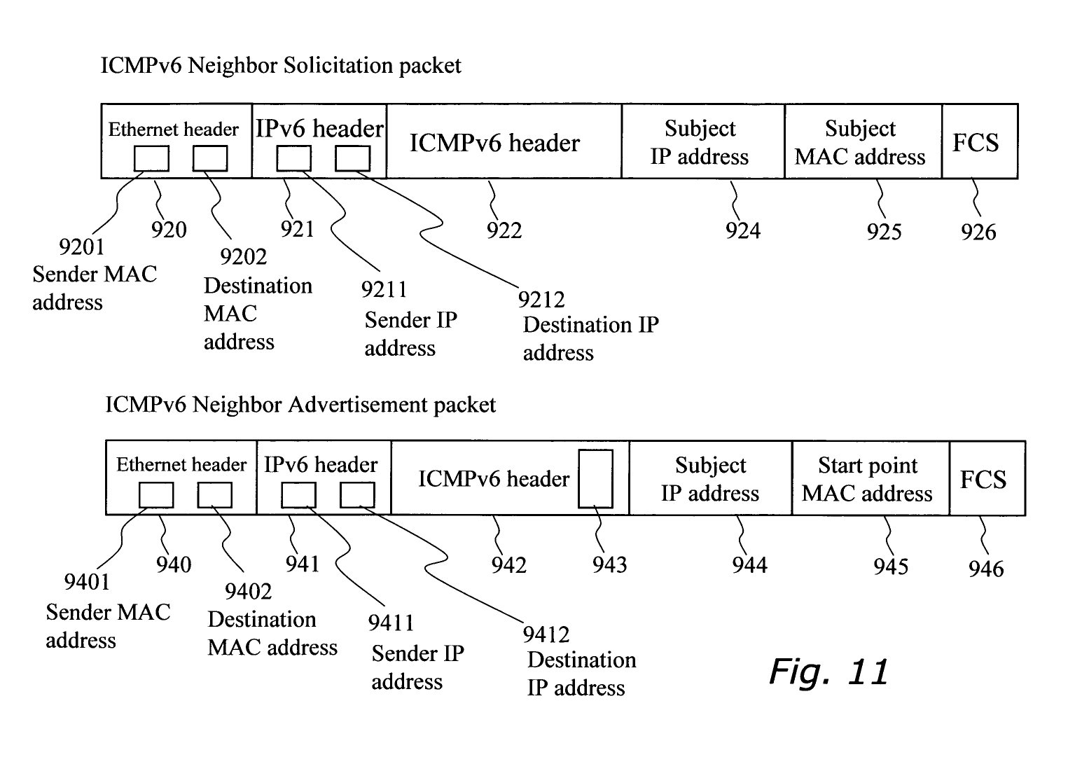

Step S1206: As a result, the ARP table 1021 of the PC 111 becomes as the table 1173 of FIG. 11. Thereafter, when the PC 111 tries to transmit lower priority communication data, it sends communication data 1064 (see FIG. 4) addressed to MAC_None (MAC address of the imaginary device 115). Because there is actually no imaginary device 115, the communication data 1064 is discarded without being received by any device. Therefore, after path change, the PC-server communication 131 that is a lower priority communication is interrupted.

Restoration control data may be transmitted as path change control data 1062 for restoring the ARP table of the PC 111 that is a device subject to control to original state. At this time, in the restoration control data the sender MAC address is changed to MAC-router. In this case, in S851 of process 1, MAC-router is also needed as information relating to a lower priority communication, notification of which is made by the priority information holding unit 841 to the path change control unit 842. Further, when the PC 111 that is a device subject to control transmits another ARP request in broadcast mode, by preventing transmission of path change control data, the interrupted lower priority communication can be restarted.

Further, the amount of lower priority communication can be adjusted by adjusting the interval between interruption and restart. For example, assuming that a lower priority communication of the PC 111 is performed using TCP, the transmission rate of the lower priority communication is gradually increased due to TCP flow control in response to restart after interruption, giving rise to more congestion after a certain period of time. For this reason, by dynamically measuring time until the next congestion, transmission rate control may be carried out so that there is another interruption immediately prior to the next congestion. Further, when interruption and restart are repeated more than once, process 3 may be omitted for the second and subsequent times.

Further, at the end of a higher priority communication, the ARP table of the PC 111 that is a device subject to control is restored to original state by the method described above, and after the end of the higher priority communication, the communication path before path change is returned to, allowing continuation of the PC-server communication 131 that is a lower priority communication.

If the transfer rate of the access line 106 that is the line at which congestion occurs is known, based on such value, determination can be made as to the interval at which interruption and restart should be performed to secure higher priority communication QoS. At this time, the formula expressing the relationship between the transfer rate of the access line 106 and the interval between interruption and restart can be calculated by experiment, for example.

A broadcast ARP request can be used as the path change control data 1062. However, in that case, it is possible that another host that received the ARP request may determine that a plurality of communication devices share the same IP address, so that communications cannot proceed normally. Further, an ARP response 1063 can be used as the path change control data 1062. However, there are cases such that when after transmission of the ARP request 1062, a device subject to control receives the ARP response 1063, no other ARP responses are received for a certain period of time, that is, when a plurality of ARP responses arrive, the first to arrive is the valid one. Further, there are also cases such that the ARP response 1063 is always received, that is, when a plurality of ARP responses arrive, the latest is the valid one. For this reason, it is possible that a process will be needed for the path change control unit 842 of the present invention to send a plurality of ARP requests—that is, path change control data 1062—so that the ARP responses given by the first router 112 arrive both before and after.

An explanation was given above for a case where the device subject to control is the PC 111 that is a device at which a lower priority communication terminates, that is, a case where the uplink path of the access line 106 is changed. Alternatively, in a case where the device subject to control is the first router 112 serving as a device for relaying a lower priority communication, that is, a case where the downlink path of the access line 106 is to be changed, the present invention can be implemented using virtually the same processes. More specifically, when determination is made in S1302 of FIG. 6 as to whether the sender IP address is that of a device subject to control, control is performed if the sender IP address is the IP address of the first router 112. As an alternative to making determination in S1303 of FIG. 6 as to whether the destination IP address is the first router 112, the invention can be configured such that control is performed when the destination IP address is not the first router 112. More specifically, the destination IP address is an IP address of a communication terminal other than the first router 112. With such a constitution, by changing a downlink path, if TCP or other flow control has been performed, data packets no longer arrive at the PC 111, the PC 111 is unable to transmit an ACK packet to the server, and the server is unable to receive the ACK packet from the PC. As a result, the server is prevented from transmitting new packets. Therefore, the transmission rate of data from the server to PC 111 can be lowered. Further, when both a device at which a lower priority communication terminates and a device that performs relay are devices subject to control, without performing S1302 and S1303, path change control data can be transmitted without fail.

With the above constitution, the first embodiment demonstrates the following effects. Because a communication device that performs priority control generates and transmits path change control data, if there is congestion between a higher priority communication and lower priority communication, the communication path of the lower priority communication is changed. Thus, priority is given to securing a communication path for the higher priority communication. With such a constitution, a communication device that performs priority control is capable of performing, in addition to the communication function, control of communications in accordance with priority. Therefore, with the connection of the above communication device that performs priority control to a household LAN or the like in which communication control in accordance with priority has not been performed, as communication is performed via a network using the communication device that performs priority control, higher priority communication QoS can be secured. Thus there is no need to separately provide a dedicated router for performing communication control in accordance with priority ranking to ensure QoS. Therefore, there is no need for a user to change existing router or system configuration, and a user can carry out high quality real-time communication such as IP telephony using any ISP provider. Further, simply by providing a communication device that performs priority control capable of ensuring QoS, the QoS of a higher priority communication device can be ensured without any change of the overall system, including lower priority communication device, higher priority communication device, and relay device.

Examples of a higher priority communication device that performs a higher priority communication include an IP telephone that requires real-time properties such as for telephone communication. Examples of a lower priority communication device include a terminal for performing file transfer. Therefore, a communication device that performs priority control can be used to ensure the QoS of an IP telephone, thereby maintaining real-time properties.

When first control data is to be transmitted to a lower priority communication device, the communication path from the lower priority communication device to the other party communication device can be changed. Further, when first control data is to be transmitted to a relay device, the communication path from the other party communication device to the lower priority communication device can be changed.

Supplementary explanations with respect to the present embodiment will be given in the following sections (Applicable Environment, Installation Location, Path Change Method, and Path Change Timing).

<Applicable Environment>

As an example of an environment to which the first IP telephone 114 having the QoS control unit 621 of the present invention can be applied, an explanation was given using the network constitution of FIG. 1. However, the present invention is applicable to more general network configurations.

Before explanation of types of network constitutions to which application can be made, a brief summary will be given regarding those processes in the constitution of FIG. 1 under which QoS problems arise.

In generation process 1, an IP telephone-IP telephone communication 132 performed between the first IP telephone 114 in the first household 101 and the second IP telephone 117 in the second household 104, and a PC-server communication 131 between the PC 111 and server 113 are simultaneously performed.

In generation process 2, the access line 106 is slower than the LAN line 107, and at the first router 112, which is the relay point, the communications compete and congestion occurs.

In generation process 3, because no priority control is performed by the first router 112, the IP telephone communication QoS degrades.

The above states can generally be described as follows.

In generation process 1, a higher priority communication and lower priority communication are simultaneously performed.

In generation process 2, congestion occurs in a device performing relay from a higher speed line to a lower speed line.

In generation process 3, because no priority control is performed by the relay device, higher priority communication QoS is degraded.

The present invention is generally applicable in such states. In other words, above, an IP telephone was given as an example of a communication device having the QoS control unit 621 of the present invention, but the communication device is not necessarily limited to a PC, server, or IP telephone, and may be a DVD recorder, IP video telephone and the like. Further, the lower speed line is not limited to an ADSL uplink line, and it may be a wireless LAN line, electric light line and the like. Further, the environment is not limited to one connected to the Internet and the invention is also applicable to closed network environments, such as a household LAN, office LAN, regional IP network and the like, where a plurality of communications are simultaneously performed.

<Installation Position>

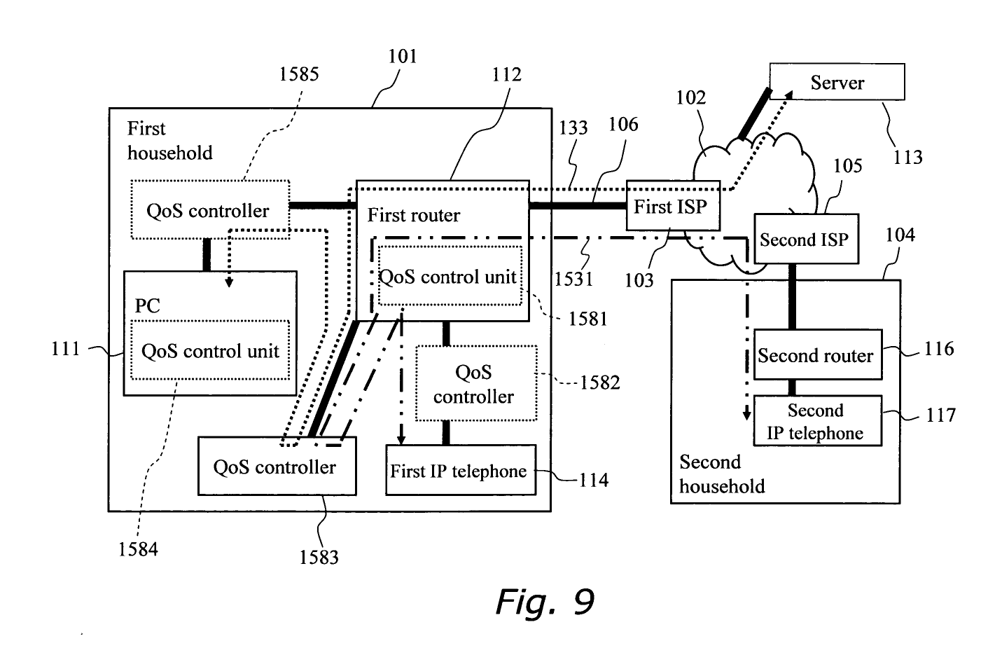

Heretofore, explanation has been given for cases where the present invention is installed as the QoS control unit 621 in the first IP telephone 114 shown in FIG. 1; however, it may be installed in other locations, as shown in FIG. 9. In FIG. 9, the network constitution is identical to that of FIG. 1 except that there are disposed at various locations the first IP telephone 114 having the QoS control unit 621 of the present invention and the QoS control units 1581-1585 having such function; therefore, detailed explanation thereof is omitted.

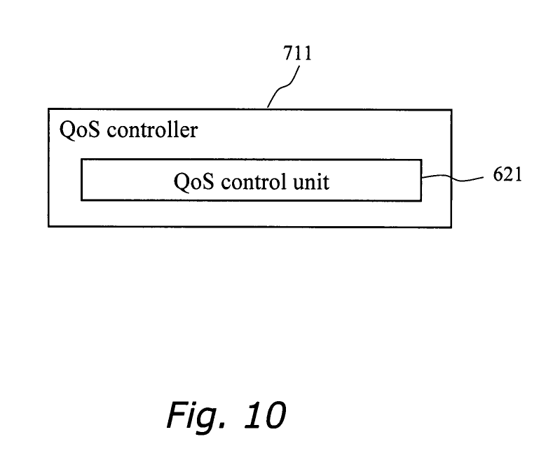

As shown in FIG. 9, the QoS control unit 621 can also be provided separately from an IP telephone, provided that it is connected to the household LAN. More specifically, the QoS controller 1583 having the above QoS control unit 621 may be provided as a terminal connected to the LAN side of the first router 112. The QoS controller 1583, as shown in FIG. 10, is a single device having only the QoS control unit 621 as a functional part. Further, the QoS controllers 1585, 1582 may be connected between the devices 111 and 114 connected to the first router 112 and the first router 112. However, in case of connection between the first router 112 and other devices 111, 114, the QoS controllers 1585, 1582 operate as a bridge for relaying communications between the first router 112 and the other devices 111, 114, or as a relay device in a data link layer that is a second layer.

Further, FIG. 1 shows a case where the present invention was implemented as the QoS control unit 621 in the first IP telephone 114 to perform QoS control processes, but as shown in FIG. 9, similar QoS control units 1584, 1581 may be included in the PC 111 and first router 112.

There are cases where by installing the first IP telephone 114 having the QoS control unit 621 of the present invention in a location other than a household LAN the effects of the invention will be demonstrated. However, this will be described later in a related section (explanation of a case where path change control data is a DNS response packet, as described in <Path Change Method>).

<Path Change Method>

Explanations heretofore were given for processes 1-4 of <Overall Flow of the QoS control process> for cases where an ARP request and ARP response are used. There are other methods where an ICMPv6 Neighbor Discovery packet is used, where an ICMP path redirect packet or ICMP v6 path redirect packet is used, where a DNS response packet is used, where a DHCP or DHCPv6 packet is used, or where software is installed in a PC. An explanation will be given below for cases where the above are used. However, the method for changing a path to be used in the present invention is not limited thereto, and any methods can be used.

A Case of Using an ICMPv6 Neighbor Discovery Packet

An explanation will be given for a process in a case of using an ICMPv6 Neighbor Discovery packet as path change control data for changing a path.

First, a brief explanation will be given regarding the functions of an ICMPv6 Neighbor Discovery packet. Neighbor Discovery for IPv6 (Internet protocol version 6) is prescribed in RFC2461, and basically provides the same functions as an ARP in IPv4 (Internet Protocol Version 4). In other words, Neighbor Discovery is a protocol for mutual notification of the correlation between IPv6 address and MAC address (address unique to network interface hardware) in an Ethernet®. Examples of an ICMPv6 Neighbor Discovery packet include a Neighbor Solicitation message corresponding to an IPv4 ARP request, Neighbor Advertisement message corresponding to an IPv4 ARP response, and the like.

The control sequence and packet flow in case where a Neighbor Advertisement packet is used as path change control data is identical to a case where the path change control data shown in FIGS. 4 and 5 is an ARP request, except for the following points; therefore, details are omitted herein.

Change 1: ARP requests 1061, 1062 are replaced with a Neighbor Solicitation packet.

Change 2: ARP response 1063 is replaced with a Neighbor Advertisement packet.

Change 3: An ARP table is replaced with an ND cache table.

With respect to changes 1 and 2, because package format also needs to be changed, a brief explanation will be given that which of the message format of an Neighbor Solicitation and Neighbor Advertisement packet, ARP request/response MAC address (912 in FIG. 3), sender IP address 913, destination MAC address 914, and destination IP address 915 correspond to which field of the Neighbor Solicitation and Neighbor Advertisement packets. FIG. 11 shows simplified formats of a Neighbor Solicitation packet and Neighbor Advertisement packet. First, a corresponding sender MAC address 9201, subject IP address 924, subject MAC address 925, and destination IP address 9212 of a Neighbor Solicitation packet in FIG. 11 respectively correspond to a sender MAC address 912, sender IP address 913, destination MAC address 914, and destination IP address 915 of an ARP request in FIG. 3. Further, a start point MAC address 945, sender IP address 9411, destination MAC address 9402, and subject IP address 944 of a Neighbor Advertisement packet in FIG. 11 respectively correspond to a sender MAC address 912, sender IP address 913, destination MAC address 914, and destination IP address 915 of an ARP response. When the Neighbor Advertisement packet is used as path change control data, in order to rewrite an ND cache of a device subject to control more securely, it is preferable that an overwrite flag 943 in the ICMPv6 header 942 is made to be effective.

Identical to applicability of an ARP response packet as path change control data, a Neighbor Solicitation packet can be used. As shown in FIG. 11, the format of a Neighbor Solicitation packet is identical to that of the Neighbor Advertisement packet, and corresponds to the ARP request. Further, as a type of an ICMPv6 Neighbor Discovery packet, there is a Router Advertisement packet that can be used as path change control data. The Router Advertisement packet is a message for communicating with a host serving as a device subject to control that the router itself is a default gateway. The host having received the same registers in the routing table, an IP address serving as a sender of the Router Advertisement packet as an IP address of a default gateway. Further, the effective time thereof is a value set in a “router effective time” field of the Router Advertisement packet. In a case where the Router Advertisement packet is thus used as path change control data, a packet with the value of the “router effective time” field set at 0 is used. At this time, the host having received such Router Advertisement packet interprets that a sender IP address of the Router Advertisement packet is no longer a default gateway, and deletes the entry from the routing table. Thus, the device subject to control is prevented from transmitting a packet thereafter.

In this state and at a value of other than 0 for the “router effective time” field, when a Router Advertisement packet in which any IP address is set as sender IP address is transmitted to a device subject to control as path change control data, the IP address set in the device subject to control can be recognized as a default gateway.

[In Case of Using an ICMP Redirect Packet]

An explanation will be given for processes 1-4 in case of using an ICMP redirect packet as path change control data for path change.

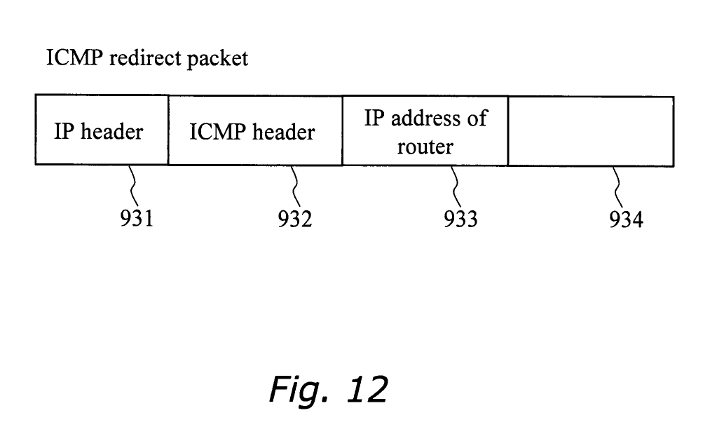

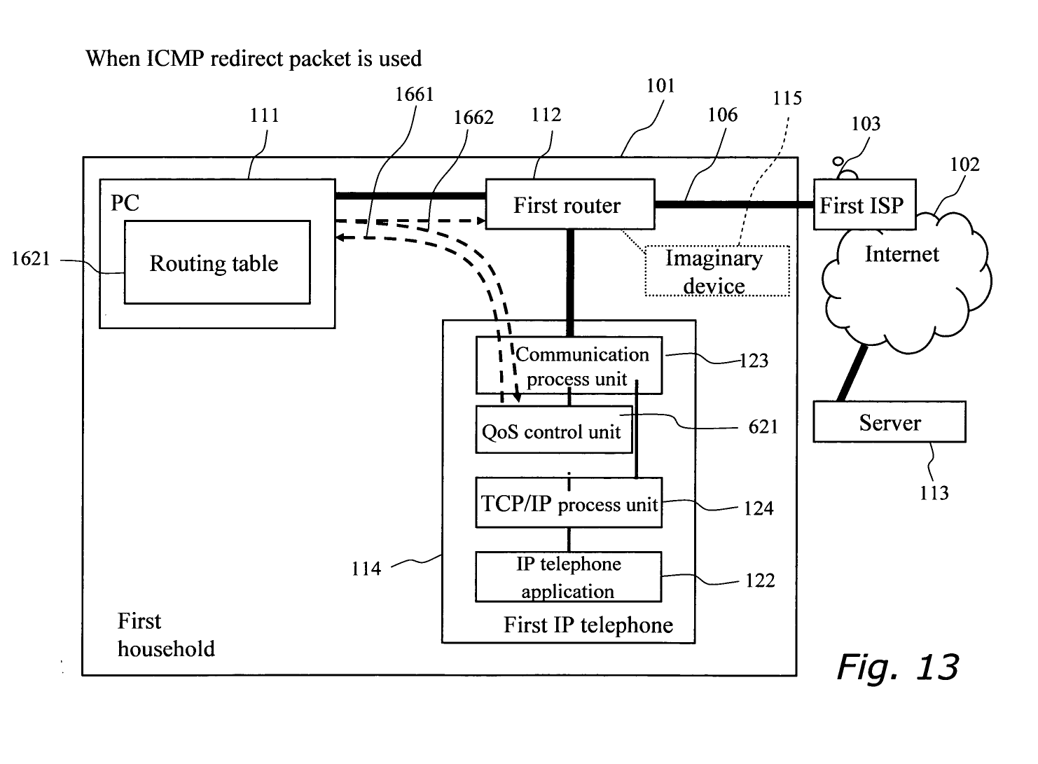

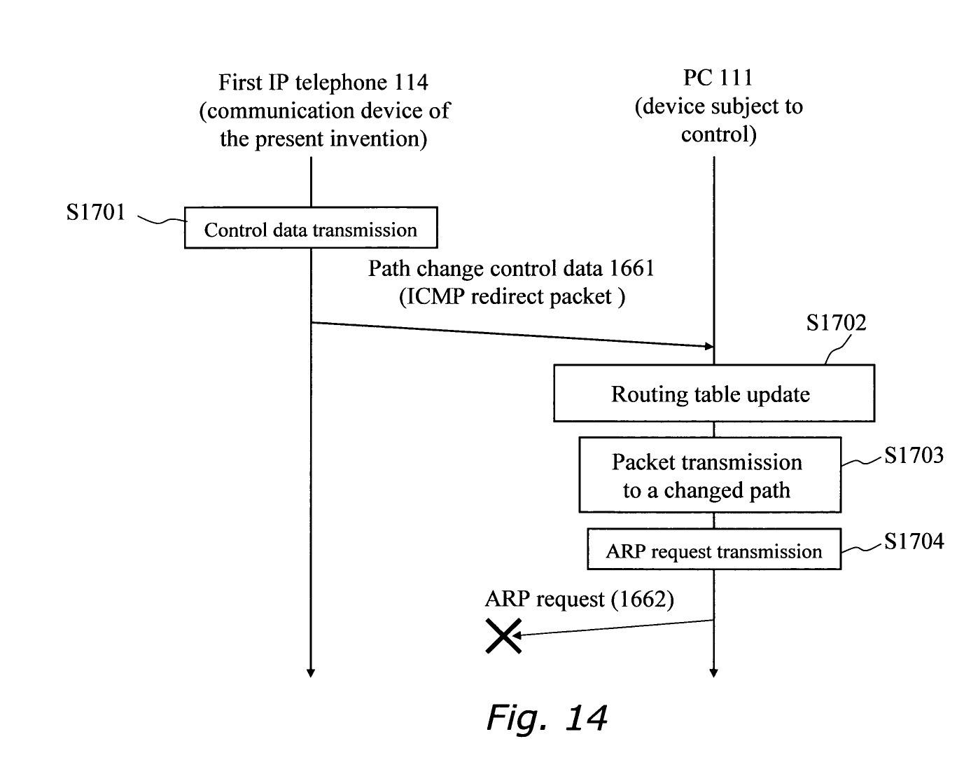

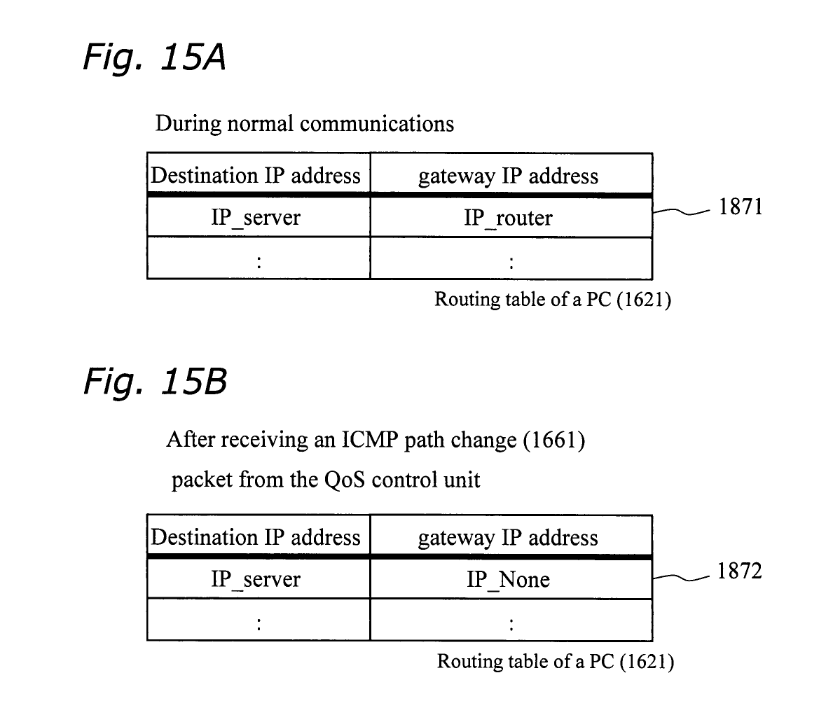

First, a brief explanation will be given of the function of an ICMP redirect packet. Normally, path control using IP is performed by referring to a routing table included in each device. The routing table has an address set therein of a router initially routed through (this is called the gateway) at time of transmitting an IP packet to the network outside the LAN. With the use of the ICMP redirect packet as path change control data, a gateway address of the routing table of a device subject to control can be rewritten, thereby changing the path for a lower priority communication. FIG. 12 shows a packet format of an ICMP redirect packet. An explanation will be given with reference to FIGS. 1, 2, 12 and 13-15 for the path change process when an ICMP redirect packet is used. FIG. 13 shows data flow of a QoS control process when an ICMP redirect packet is used, and shows how data 1661, 1662 to be handled are moved in the network. FIG. 14 shows an example of process and data flow of a QoS control process when an ICMP redirect packet is used, and shows handling of data according to the present processing and time-line of the QoS control process in the first IP telephone 114. FIGS. 15A, 15B show routing tables of units to be controlled, and show how the routing table 1621 of the PC 111 is updated as needed in the following process. In the following process, the PC 111, first router 112, server 113, first IP telephone 114, and MAC and IP addresses of an imaginary unit 115 are as defined in FIG. 8.

(1) Process 1

Process 1 will be explained with reference to FIG. 2. First, in the present embodiment, let us assume that the IP telephone communication performed by the first IP telephone 114 that is an own device is a higher priority communication, and all other communications from inside the LAN toward the Internet via the first router 112 are lower priority communications, and the QoS control unit 621 of the present invention operates. At this time, the priority information holding unit 841 of FIG. 2 has, as default information, an IP_router value necessary for path change control by an ICMP redirect packet. IP_router, as shown in FIG. 8, is the IP address of the first router 112 that relays communications from the PC 111 and first IP telephone 114 to the network 2. As an alternative to being default information, this information may be input from a user interface, or acquired in some process using the network.

Next, the priority information holding unit 841 gives notice of IP_router and IP_PC to the path change control unit 842 as information relating to lower priority communication (see FIG. 2, S851). Instead of including the IP address of the device subject to control, the same can be acquired from a broadcast ARP request transmitted by the device subject to control as process 2.

(2) Process 2

Explanations will be given for process 2 and subsequent processes with reference to FIGS. 13 and 14. Reference will be made to FIG. 12 for format of the ICMP redirect packet.

Step S1701: The path change control unit 842 of the first IP telephone 114 transmits an ICMP redirect packet as path change control data 1661. At this time, the sender address of the IP header 931 of the ICMP redirect packet is assumed to be IP_router, and the destination address is assumed to be IP_PC. Further, as an IP address 933 of a router, IP_None is designated as the IP address of an imaginary unit. The IP address of an imaginary unit is any address that is not an IP address of a unit included in the household LAN.

(3) Process 3

The routing table of the PC 111 prior to receipt of the path change control data 1661 is configured as table 1871 in FIG. 15A. IP_router is set as the IP address of a gateway for transferring a packet addressed to the server 113 in FIG. 1.

Step 1702: Upon receiving the path change control data 1661, the PC 111 updates its own routing table. At this time, the routing table is configured as table 1872 in FIG. 15B, and an imaginary IP address IP_None is correlated to be transfer destination of a packet addressed to the server 113.

(4) Process 4

Step S1703: With the above process, any communication data the PC 111 attempts to transmit to the server 113 is lower priority communication data with the IP address of the imaginary unit as gateway.

Step S1704: At this time, in order to actually transmit data, because the PC 111 needs to know the MAC address corresponding to the imaginary IP address IP_None, the broadcast ARP request 1662 is transmitted. However, because no device has the designated destination IP address 915, the ARP request 1662 is discarded. As a result, the PC 111 is prevented from transmitting the data of a lower priority communication, causing the PC-server communication to be interrupted after the path change.

With transmission of return control data as path change control data for returning the routing table of the PC 111 as a device subject to control to original state, the interrupted lower priority communication can be restarted. Further, the amount of lower priority communication can be adjusted by adjusting the interval between interruption and restart. Further, when interruption and restart are repeated more than once, process 1 may be omitted for the second and subsequent times. Based on the transfer rate of the access line 106 shown in FIG. 1 that is the line at which congestion occurs, if known, determination can be made as to the interval at which interruption and restart should be performed to secure higher priority communication QoS. At this time, the relational expression between the transfer rate of the access line 106 and interval between the interruption and restart can be calculated by performing, for example, an experiment.

Further, when a higher priority communication ends, the routing table of the device subject to control is brought back to its original state by the above method so that, after the higher priority communication ends, the communication path prior to path change is restored, allowing continuation of the PC-server communication 131 that is a lower priority communication.

The above ICMP redirect packet can be used only in an IPv4 network. In an IPv6 network, an ICMPv6 path change packet for achieving identical effects is used. The process when an ICMPv6 path change packet is used as path change control data is identical to a case where the above ICMP redirect packet is used, and details thereof are omitted here.

[In Case of Using a DNS Response Packet]

An explanation will be given for processes 1-4 in case of using a DNS response packet as path change control data for path change.

First, a brief explanation will be given for a DNS (Domain Name System). The DNS is a function for, based on a host name shown in the form FQDN (Fully Qualified Domain Name) (e.g. www.panasonic.co.jp), learning the corresponding IP address.

A communication application transmits to the DNS server a DNS inquiry packet that includes an FQDN for using the DNS, receives a DNS response packet (including an IP address corresponding to the inquired FQDN) transmitted from the DNS server in response thereto, and thereafter performs communications with respect to the IP address.

A brief explanation will be given with reference to FIGS. 1, 2 and 8 for a path change process when the DNS response packet is used. The relationship between FIG. 1 and FIG. 2, and FIG. 8 are as explained above.

(1) Process 1

Process 1 will be explained with reference to FIG. 2. First, in the present embodiment, let us assume that the IP telephony communication performed by the first IP telephone 114 itself is a higher priority communication, and all other communications from inside the LAN toward the Internet 2 via the first router 112 are lower priority communications, and that the QoS control unit 621 of the present invention operates. At this time, the priority information holding unit 841 of FIG. 2 has, as default information, an IP_router value and a MAC_router value necessary for path change control by a DNS response packet. As an alternative to being default information, this information may be input from a user interface, or acquired in some process using the network.

Next, the priority information holding unit 841 gives notice of IP_router and MAC_router to the path change control unit 842 as information relating to lower priority communication (see FIG. 2, S851).

(2) Process 2

The method used in a case of an ARP request, ARP response or ICMP redirect packet is applied to change the destination of the DNS inquiry packet to the first IP telephone 114 containing the QoS control unit 621 of the present invention. The IP_router acquired as information relating to a lower priority communication is used here.

The first IP telephone 114 receives a DSN inquiry packet and stores various information necessary for creating a DNS response packet such as an FQDN. The path changed by the ARP request, ARP response or ICMP redirect packet can be restored at any time thereafter.

The path change control unit 842 of the first IP telephone 114 transmits the DNS response packet as path change control data to the PC 111 that is a device subject to control. At this time, IP_None (see FIG. 8), which is the IP address of an imaginary device corresponding to the FQND included in the DNS inquiry packet, is set. The sender IP address and destination IP address of the path change control data are those after replacement with, which the sender IP address and destination IP address of the DNS inquiry packet. Also, as the sender MAC address, the acquired IP_router is set as information relating to a lower priority communication

(3) Process 3

The PC 111 that is a device subject to control, after receiving the path change control data, transmits data of the lower priority communication with a non-existent IP address as a destination.

(4) Process 4

However, non-existence of a destination host is detected by one of the routers in the communication path, causing an ICMP Destination Unreachable message to be transmitted to the PC 111. The PC 111, upon receipt of the same, detects an error, and normally interrupts the communication application.

In the section <Installation Position>, it was stated that the PC 111 that is a device subject to control and the first IP telephone 114 having the QoS control unit 621 of the present invention need to be included in the same LAN. However, if a DNS response packet is used as path change control data, the device subject to control and the first IP telephone 114 having the QoS control unit 621 of the present invention do not necessarily have to be included in the same LAN. For this reason, the device subject to control may be either one of the two terminals for performing lower priority communications. Further, the first IP telephone 114 having the QoS control unit 621 of the present invention can be located anywhere provided that an IP communication can be performed with the device subject to control.

The above DNS response packet can be used in both IPv4 and IPv6.

[In a Case of Using DHCP and DHCPv6]

Next, an explanation will be given for a case where DHCP and DHCPv6 are used. DHCP (Dynamic Host Configuration Protocol) is a protocol for acquiring an IP address of a host that is a client, and information such as default gateway and DNS server to be used, and can be used in an IPv4 network. After exchanging messages for a client to detect a server, the DHCP transmits to the detected server a DHCP REQUEST packet, and receives a DHCPACK (DHCP response) packet transmitted from the server in response thereto (including the above described information), thereby setting up the client.

Further, DHCPv6 is a protocol that can be used with IPv6 that provides functions almost identical to those of the DHCP, except that the default gateway cannot be set in DHCPv6. Further, while in DHCP a server responds to a request from a client without fail, in DHCPv6, a RECONFIGURATION packet for overwriting the configuration by the server can be used.

With the use of a DHCPACK packet and RECONFIGURATION packet in these protocols as path change control data, the default gateway of a device subject to control can be changed, achieving effects identical to those of the above case where an ICMP redirect packet is used. With the change of the DNS server to which a device subject to control refers, effects identical to those of the prior path change method by the ARP request in the above case where a DNS response packet is used are achieved.

DHCP is stipulated in RFC2131, and DHCPv6 is stipulated in RFC3315.

[In a Case of Using a Software on a PC]

An explanation will be given for processes 1-4 when path change control is performed using a software installed on a PC.

In a case where the device subject to control is a general computer such as a PC, by having software installed therein, path of data to be transmitted by the device subject to control can be changed. Installation of software onto the PC should be completed before the present process starts. Such process will be explained with reference to FIGS. 1, 2 and 12. The relationship between FIG. 1 and FIG. 2, and FIG. 12 are as explained above.

(1) Process 1

In the present method, there is no need to perform process 1 for giving notification of information relating to lower priority communication from the priority information holding unit 841 to path change control unit 842.

(2) Process 2

The path change control unit 842 of the QoS control unit transmits in broadcast mode, as path change control data, a special packet that can be recognized by the software installed in the PC 111. If the address (IP_PC or MAC_PC) of the PC 111 that is a device subject to control is known in advance, the transmission can be performed in unicast. In the path change control data, as information of an address that is to be a transfer destination, a non-existent address is set. If the transfer address is known in advance, the same may be registered in the software of the PC in advance.

(3) Process 3

The PC 111 that is a device subject to control, having received the path change control data, using the software installed in advance, rewrites its own ARP table and routing table, or rewrites the destination MAC and IP addresses of the communication data using some method.

(4) Process 4

Thereafter, the PC 111 transmits data of the lower priority communication with the non-existent MAC address and IP address as a destination. As a result, the PC-server lower priority communication is interrupted.

By transmission of path change control data to restore the data transfer destination of the device subject to control to original state, the interrupted lower priority communication is restarted. Further, the amount of lower priority communication can be adjusted by adjusting the interval between interruption and restart.

Further, when higher priority communication ends, the ARP table of the device subject to control is restored to original state by the above method, restoring the communication path before path change, allowing continuation of the PC-server communication 131 that is a lower priority communication.

<Path Change Timing>

Conventionally, the path was changed at time of starting a higher priority communication, and restoration of the original path was at the end of the higher priority communication. The present invention is not limited to such a configuration. An explanation will be given for path change timing.

The timing at which path change control data is transmitted to a device subject to control differs depending on path change control data. For example, in a case where the path change control data is an ARP request, the path change control data can be transmitted at any time after the device subject to control once transmits an ARP request. However, if the path change control data is a DNS response packet, after the device subject to control transmits a DNS inquiry packet, by the time the DNS response packet can no longer be received due to timeout of a reception standby process for the DNS response packet, path change control data from the first IP telephone 114 having the QoS control unit 621 of the present invention needs to be received.

While the timing at which the path change control data can be transmitted differs, an explanation will be given for the timing for changing a communication path based on the received path change control data, and effects therefrom. However, the timing at which the present invention is applied to is not limited to the following, and any timing can be used.

First, the following represents conceivable timing for changing the communication path for lower priority communication from the usual communication path to another communication path.

Timing 1: A communication path for lower priority communication can be changed at time of turning on the power source of the first IP telephone 114 having the QoS control unit 621 of the preset invention, at time of connecting the first IP telephone 114 having the QoS control unit 621 of the present invention to the household LAN, or at time of first implementation after such turning on or connection, that is, when an ARP request packet has been received and a process can be started. In this case, a path can be changed on a permanent basis, facilitating installation.

Timing 2: A communication path for lower priority communication is changed at the time of starting a higher priority communication. In this case, because the communication path can be changed only when there is the possibility that communications may compete, there is less influence on the lower priority communication from changing the communication path.

Timing 3: A communication path for lower priority communication is changed when the quality of the higher priority communication is degraded. In this case, although the control becomes complicated, the time during which the communication path is changed can be further shortened compared to the above timing 2. The criteria used for judging degraded quality are statistical information relating to degraded quality of the higher priority communication (delay, jitter, packet loss rate and the like). As an easy method for causing the first IP telephone 114 having the QoS control unit 621 of the present invention to acquire information relating to the quality of the higher priority communication, quality information is collected by the device at which a higher priority communication terminates and a packet including such information is transmitted to the first IP telephone 114. Alternatively, in a case where there is a QoS control unit in a device at which the higher priority communication terminates, quality information can be transferred within the device.

Next, the following represents conceivable timing for restoring a changed communication path to original state.

Timing 1: The communication path is restored to original state at time of shutting down and rebooting the first IP telephone 114 having the QoS control unit 621 of the present invention. In this case, during the time when the first IP telephone 114 cannot carry out control, influence on the lower priority communication is eliminated.

Timing 2: The communication path is restored to original state when the higher priority communication ends. In this case, because the communication path can be changed only during the time when there is the possibility that communications may compete, influence on the lower priority communication from changing the communication path is reduced.

Timing 3: The communication path is restored to original state when judgment is made that the quality of the higher priority communication can be secured even after the communication path is restored to original state due to decrease in the amount of a lower priority communication. In this case, although the control becomes complicated, the time during which the communication path is changed can be further shortened compared to the above timing 2. The criteria for judging whether the quality of the higher priority communication can be secured even when the path is brought back are statistical information relating to the quality of the higher priority communication (delay, jitter, packet loss rate and the like). As an easy method for causing the first IP telephone 114 to acquire information relating to the quality of the higher priority communication, quality information is collected by the device at which a higher priority communication terminates and a packet including such information is transmitted to the first IP telephone 114. Alternatively, in a case where there is a QoS control unit in a device at which the higher priority communication terminates, quality information can be transferred within the device.

Priority information holding unit in the claims corresponds to the priority information holding unit 841, and path change control unit in the claims corresponds to the path change control unit 842.

### Second Embodiment

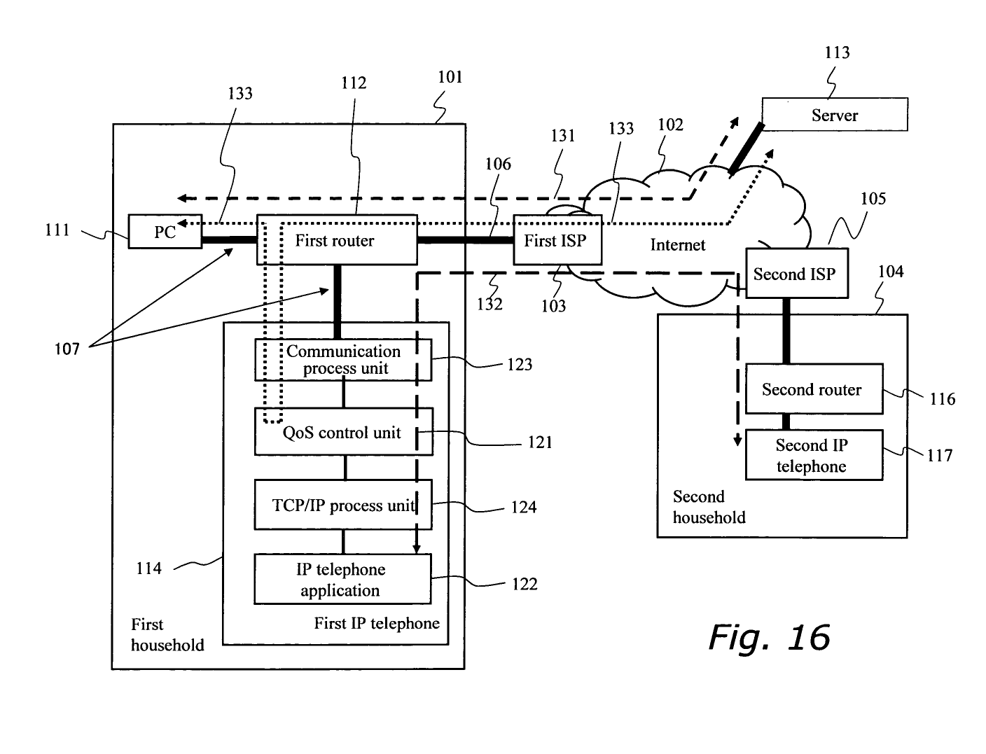

Next, a second embodiment of the present invention will be explained with reference to the drawings. FIG. 16 is a diagram of a network constitution relating to the second embodiment. In FIG. 16, a PC 111 and first IP telephone 114 are connected to the LAN side of a first router 112 included in a first household 101, forming a household LAN. Further, this household LAN is connected to the Internet 102 via an access line 106 and first ISP 103. Further, there is a second router 116 in a separate second household 104, and a second IP telephone 117 is connected to the LAN side thereof. The household LAN of this second household 104 is connected to the Internet 102 via a second ISP 105.

Further, in FIG. 16, a file transfer 131 (hereinafter, PC-server communication 131) is performed between the PC 111 in the first household 101 and a server 113 on the Internet 102, and an IP telephone communication 132 using the Internet 102 (hereinafter, IP telephone-IP telephone communication 132) is performed between the first IP telephone 114 in the first household 101 and the second IP telephone 117 in the second household 104.

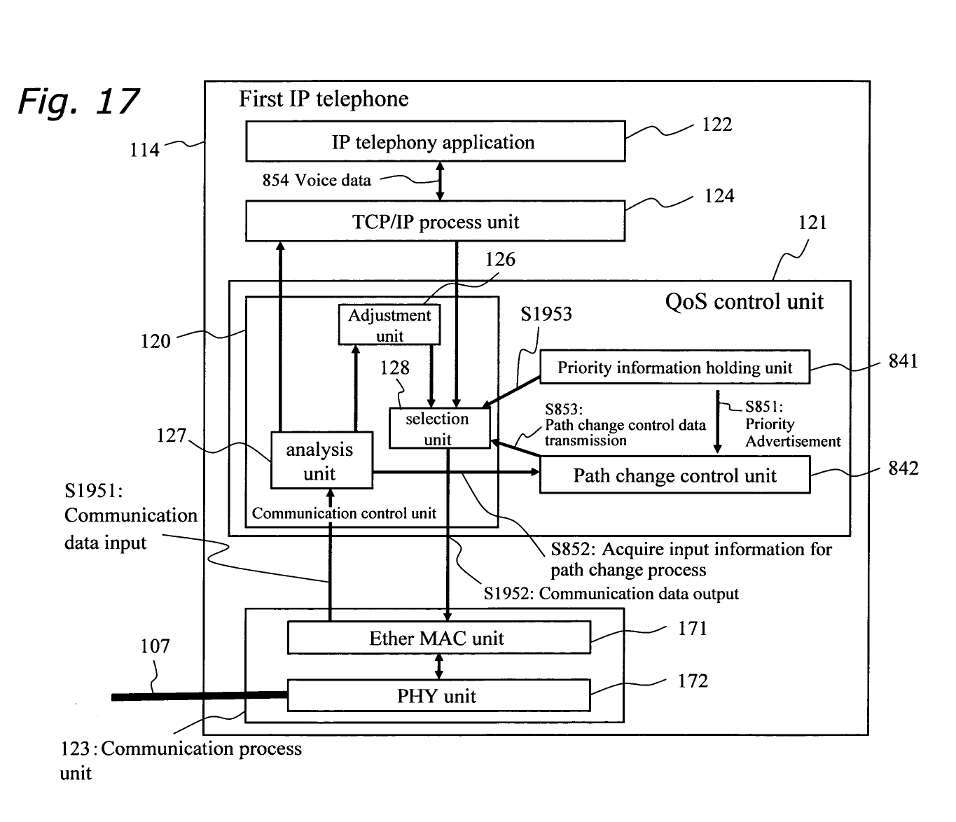

Further, in FIG. 16, a QoS control unit 121 is installed as a functional part of the first IP telephone 114. FIG. 17 shows in greater detail the internal constitution of the IP telephone 114 and QoS control unit 121 of FIG. 16. As shown in FIG. 17, the QoS control unit 121 includes a priority information holding unit 841, path change control unit 842, and communication control unit 120. The communication control unit 120 controls output of data transmitted from the lower priority communication device to the network, and includes an analysis unit 127, selection unit 128 and adjustment unit 126. The path change control unit 842 is capable of receiving data from the LAN line 107 via the communication process unit 123 in the first IP telephone 114 and transmitting data to the LAN line 107. Here, the communication process unit 123 conforms to Ethernet® protocols. More specifically, the communication process unit 123 comprises a PHY unit 172 and Ether MAC unit 171. Further, voice data of the IP telephone is generated by the voice data generator 122, and transmitted via the communication process unit 123 to the LAN line 107. The IP telephone-IP telephone communication 132 requires real-time properties, and is a higher priority communication having higher priority. On the other hand, the PC-server communication 131 is a lower priority communication having lower priority. Further, the first IP telephone 114 is a higher priority communication device and the PC 111 is a lower priority communication device.

The present embodiment differs from the first embodiment as follows. The first embodiment is configured such that when a path is changed, the device subject to control is made to recognize a non-existent address as destination so as to interrupt the lower priority communication, whereas the second embodiment is configured such that the device subject to control is made to recognize the address of the first IP telephone 114 having the QoS control unit 121 as destination so as to cause the QoS control unit 121 to temporally receive the lower priority communication data. More specifically, in the first embodiment, the QoS control unit is caused only to change the communication path, whereas in the second embodiment, the QoS control unit 121 further comprises the analysis unit 127, selection unit 128 and adjustment unit 126, and performs more detailed control with respect to the received lower priority communication data.

The process in the second embodiment under which, as shown in FIG. 16, the first IP telephone 114 having the QoS control unit 121 of the present invention changes the communication path of the lower priority PC-server communication 131 to path 133 routed through the first IP telephone 114, and the first IP telephone 114 performs detailed QoS control, thereby ensuring higher priority communication QoS, will be discussed. First, an overview of the QoS control process of the present invention will be described in <Overall Flow of the QoS control process>, then details of each process will be described in <Detailed QoS control processes>.

<Overall Flow of the QoS Control Process>

The QoS control process according to the second embodiment is in general performed as follows.

First, let us assume that prior to performance of the QoS control process only a lower priority communication (PC-server communication 131) is being carried out in the network of FIG. 16. Subsequently, when a higher priority communication (IP telephone-IP telephone communication 132) starts, the following control is performed by the QoS control unit 121. An explanation will be given with reference to FIG. 17.

(1) Process 1

The priority information holding unit 841 holds priority information for distinguishing a lower priority communication from a higher priority communication, and gives notification of the same to the path change control unit 842 (S851). The first IP telephone 114 is set as a higher priority communication device that performs a higher priority communication, and the PC 111 is set as a lower priority communication device that performs a lower priority communication.

(2) Process 2

The path change control unit 842 acquires information required for generating path change control data to change a path, for example, an IP address (S852). The collected information varies depending on path change method.

The path change control unit 842 generates path change control data from the information acquired in this process and the information acquired in the process 1, and transmits the path change control data for changing a path to the PC 111 as the device subject to the path change control, a lower priority communication (S853) terminates or is relayed.

The communication process unit 123 transmits the path change control data to the LAN line 107. The path change control data includes information with respect to destination after changing the data output from the PC 111 that is a lower priority communication device. In the present embodiment, the address of the first IP telephone 114 having the QoS control unit 121 of the present invention is the destination after path change.

(3) Process 3

The PC 111 that is a lower priority communication device and device subject to control receives the path change control data, and transmits subsequent lower priority communication data to the changed communication path, that is, a path routing through the first IP telephone 114 as a communication device having the QoS control unit 121.

(4) Process 4

The QoS control unit 121 receives lower priority communication data via the communication process unit 123 (S1951), performs some process with respect to the lower priority communication data at the analysis unit 127, adjustment unit 126 or selection unit 128, and thereafter transfers the same to the correct destination (S1952). At this time, the communication path of the lower priority communication becomes PC-server communication 133 after path change in FIG. 16.

<Detailed QoS Control Processes>

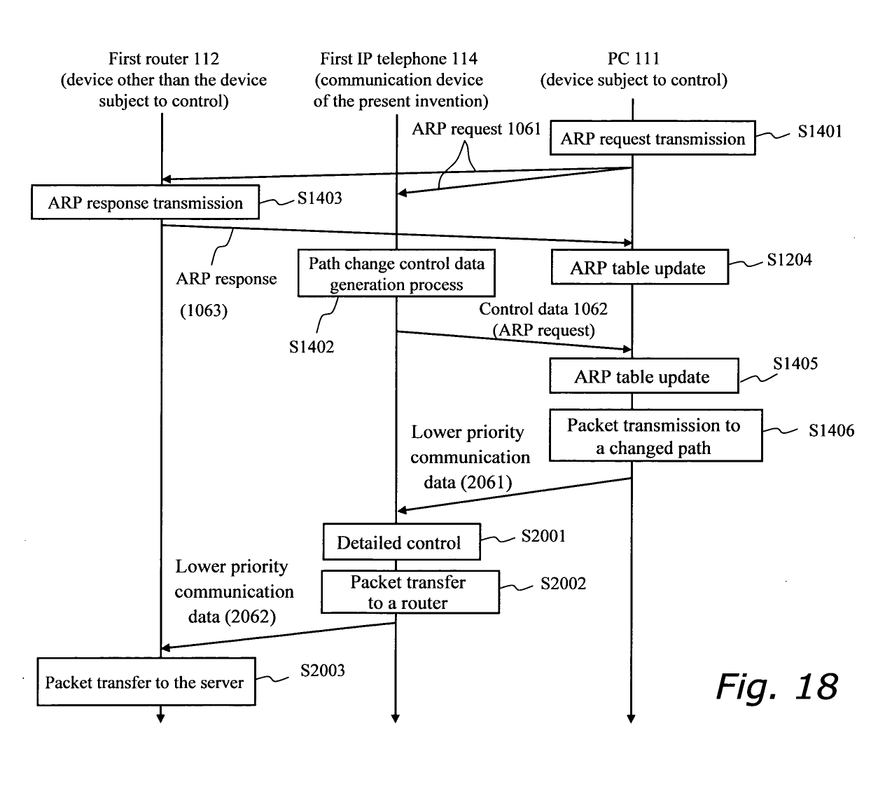

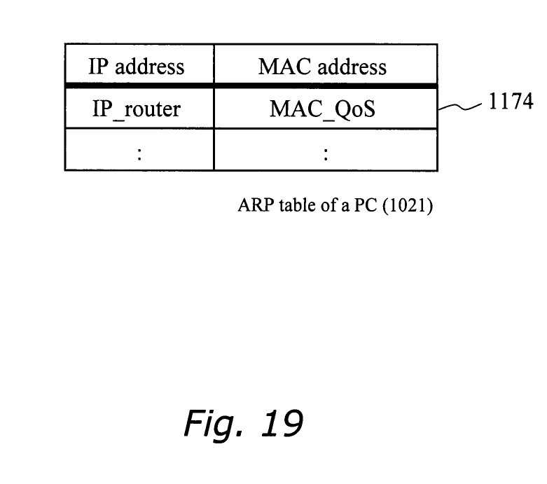

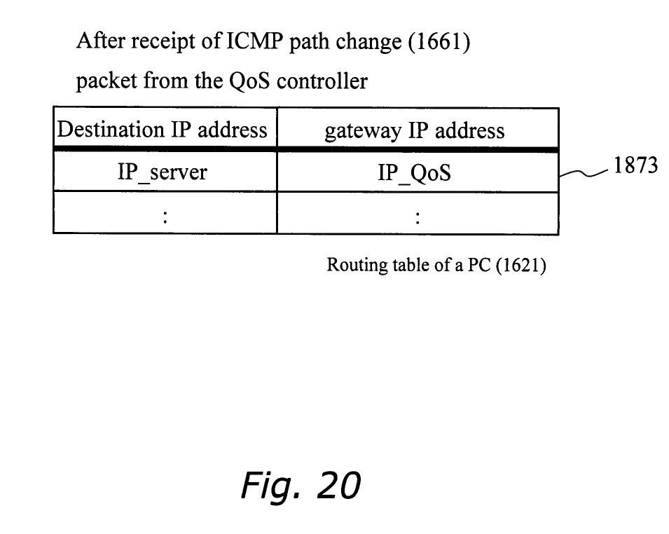

Next, the processes 1-4 of the <Overall Flow of the QoS control process> will be described in detail with reference to FIG. 16 and FIGS. 17-20. FIG. 17 is a block diagram of a QoS control unit and IP telephone according to the second embodiment and shows the handling of data in the present process and a time-line of the processing by the first IP telephone 114. FIG. 18 is an example of processing and data flow when detailed control is performed after path change control. FIGS. 19 and 20 show how the ARP table of the PC 111 and routing table are updated as needed.

An explanation will be given in accordance with the process flow.

(1) Process 1

Process 1 will be explained with reference to FIG. 17. First, in the present embodiment, let us assume that the IP telephony communication performed by the first IP telephone 114 as an own device is a higher priority communication, and all other communications from inside the LAN toward the Internet 2 via the first router 112 is lower priority communication, and that the QoS control unit 621 of the present invention performs operation. At this time, the priority information holding unit 841 of FIG. 17 has, as default information, an IP_router value necessary for path change control by ARP request.

Next, the priority information holding unit 841 notifies the path change control unit 842 of IP_router as information relating to a lower priority communication (see FIG. 17, S851).

(2) Process 2

Step S1401: Next, as in S1201 in FIG. 5, the PC 111 that is a device in the LAN at which a lower priority communication terminates transmits a broadcast ARP request 1061 with the IP_router that is the IP address of the first router 112 initially routed through for the purpose of communication with the server 113 as a destination IP address 915.

The routing table of the PC 111 after receipt of the ICMP redirect packet is as shown as table 1873 in FIG. 20. Further, the above difference does not depend on whether path change control data uses an ARP request, ARP response, ICMP redirect packet, DNS response packet, or special packet that can be recognized by a software on a PC; therefore, an explanation of <Path Change Method> will be omitted in the present embodiment.

Subsequently, the path change control unit 842 in the QoS control unit performs a path change control data generation process in S1402. Only the changed destination address of a communication path as set by the path change control data is different from the first embodiment, and the details of other process are as described in the flowchart in FIG. 13 of the first embodiment, and thus an explanation thereof is omitted. The destination IP address 915 and sender address 913 designated here are those after substitution with the destination IP address 915 and sender IP address 913 of the received ARP request 1061. Further, for the sender MAC address 912, MAC_QoS serving as MAC address of the first IP telephone 114 having the QoS control unit 121 is set.

(3) Process 3

Step S1405: The PC 111 that as a device subject to control received the path change control data 1062 updates the APR table based on the path change control data 1062. The state of the APR table at this time is as shown as the table 1174 in FIG. 19, and a MAC_QoS serving as MAC address of the first IP telephone 114 having the QoS controller 121 is registered as the MAC address corresponding to IP_router.

(4) Process 4

Step S1406: Next, the PC 111 transmits the communication data. At this time, because a communication path for lower priority communication has already been changed in process 3 to a path to the first IP telephone 114 having the QoS control unit, the communication data 2061 is transmitted to the first IP telephone 114.

The first IP telephone 114 receives the communication data 2061, and performs detailed control (S2001) and transmission. An explanation will be given of an example of the receiving process and transmission process (including detailed control) with reference to FIGS. 17, 21, 22 and 23.

[Receiving Process]

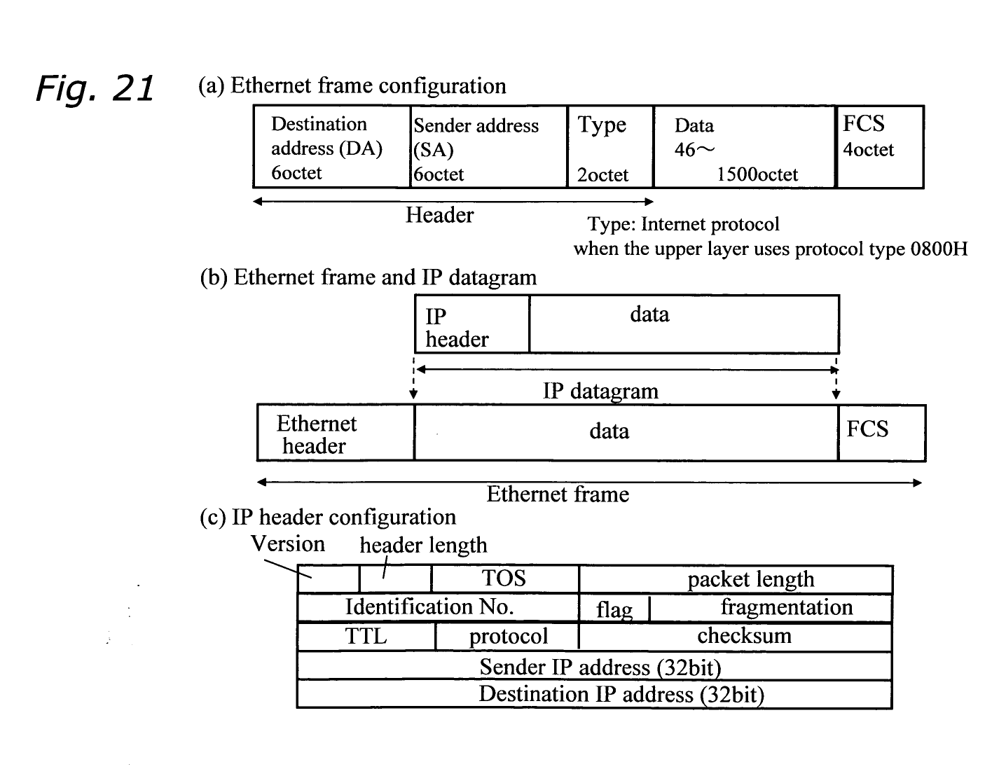

An Ethernet® frame (FIG. 21(a)) routed to the first IP telephone 114 is extracted by the Ethernet® MAC unit 171 after passing through the PHY unit 172. The Ethernet® MAC unit 171 transmits the destination address (DA), sender address (SA), type, and payload data of the extracted frame to the analysis unit 127 inside the QoS control unit 121.

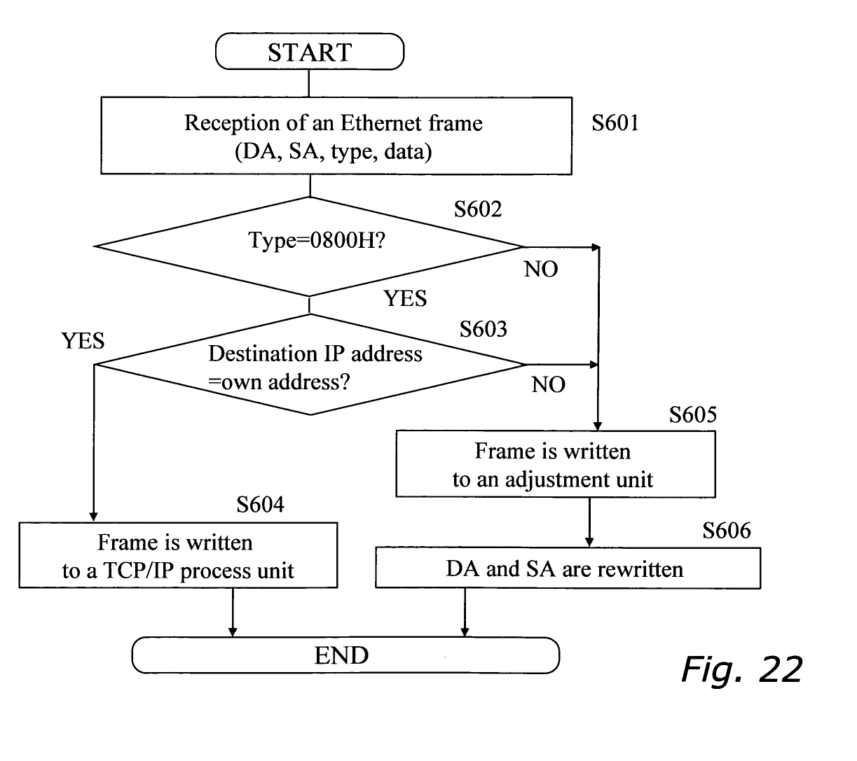

The analysis unit 127 performs operations as shown in FIG. 22. More specifically, upon receiving the Ethernet® frame (DA, SA type, data) from the Ethernet® MAC unit 171 (S601 in FIG. 22), the analysis unit 127 checks whether an IP packet is stored in the frame based on the type region. If the type value is 0x0800, IP is used and its own device (first IP telephone 114) (S602) is a candidate for receipt thereof. Next, as indicated by S603, destination IP address is checked based on the IP header (FIG. 21(c)) inside of the Ethernet® frame (FIG. 21(b)) to judge whether the frame is to be received. If it is subject to reception, the frame is transmitted to the TCP/IP process unit 124 that is an upper level processor (S604). Frames not using IP in S602 and those not addressed to the own unit in S603 are written to the adjustment unit 126 (S605), and the DA and SA of the frames are rewritten by the adjustment unit 126 (S605). Specific contents of the rewriting will be described later. The adjustment unit 126 comprises a storing unit capable of storing frames. Further, the storing unit does not need to be included in the adjustment unit 126, and may be provided separately from the adjustment unit 126.

The TCP/IP process unit 124 performs TCP/IP processing with respect to the Ethernet® frame received from the analysis unit 127, and transfers the same to a suitable terminal application such as an IP telephony application 122.

[Transmission Process]

Data transmitted from the IP telephony application 122 is subject to transmission protocol processing by the TCP/IP process unit 124 as upper layer processor to constitute an Ethernet® frame, and a transmission request is issued to the selection unit 128 in the QoS control unit 121.

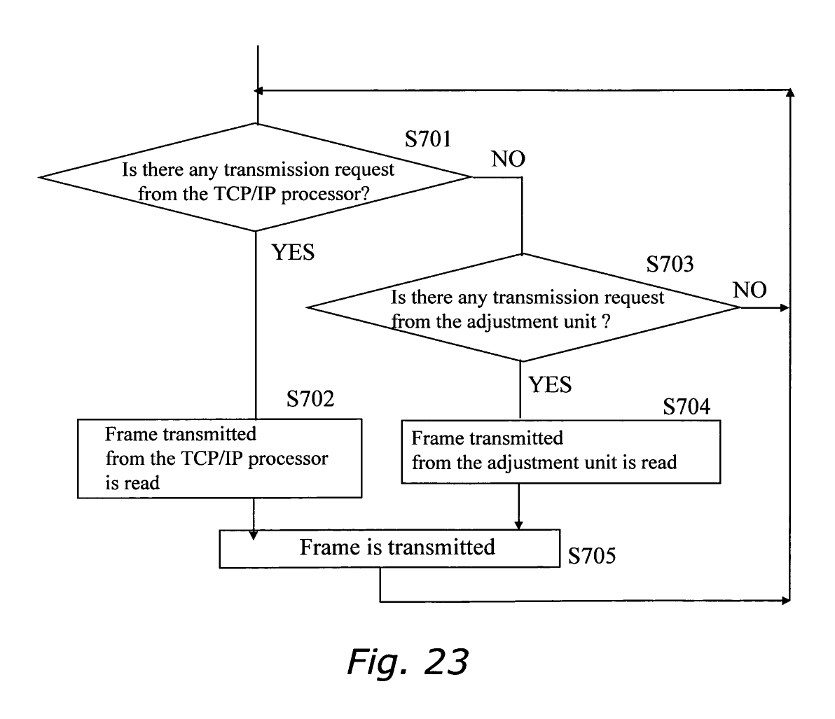

The selection unit 128 performs operations as shown in FIG. 23. More specifically, if there is a transmission request from the TCP/IP process unit 124 (S701), the frame is read (S702) and transmitted to the Ethernet® MAC unit 171 (S705). On the other hand, if there is no request from the TCP/IP process unit 124 (S701), check is made as to whether there has been a subsequent transmission request from the adjustment unit 126 (S703) (a control data packet transmission request from the path change control unit, if any, is handled identically with transmission from the adjustment unit 126). If there is a transmission request from the adjustment unit 126, the frame is read from the adjustment unit 126 (S704) and transmitted to the Ethernet® MAC unit 171 (S705). Upon completion of frame transmission (S705), another check is made as to whether there has been a transmission request from the TCP/IP process unit 124 (S701).

The Ethernet® MAC unit 171, having received the frame to be transmitted performs MAC processing such as providing an FCS (Frame Check Sequence) and transmits the frame to the transmission channel via the PHY unit 172.

In particular, by constituting the analysis unit, adjustment unit and selection unit with hardware, a CPU that executes terminal applications and TCP/IP processing will not be influenced by PC 111 transmission/reception frames, as it can avoid processing frames not addressed to its own device.

An explanation will be given for how the first IP telephone 114 thus operated functions to perform priority control with respect to a frame to be transmitted from the PC 111 to the server 113.

First, as described above, an Ethernet® frame addressed from the PC 111 to the server 113 is routed through the first IP telephone 114. In such a case, the Ethernet® frame transmitted from the PC 111 was initially transmitted with the MAC address of the first router 112 as a destination address, but after the ARP table and the like are rewritten due to the path change, the MAC address of the first IP telephone 114 becomes the destination address. However, because no change has been made to the server 113 as communication counterparty, the destination IP address remains the IP address of the server 113.

Because the destination MAC address is the first IP telephone 114, the Ethernet® frame transmitted from the PC 111 will arrive having made a detour through the first IP telephone 114. In the first IP telephone 114, because the destination IP address of the frame is the server 113, not itself, as described above using FIG. 5, the analysis unit 127 writes to the adjustment unit 126. More specifically, while the destination MAC address is set as the first IP telephone 114, the IP address of the server 113 that is the original destination is set as the upper level protocol destination IP address. For this reason, notwithstanding the transmission from the PC 111 to the server 113, the analysis unit 127 can distinguish between an Ethernet® frame detoured to the first IP telephone by rewriting of the ARP table and transmitted to the server 113 and an Ethernet® frame with the first IP telephone 114 itself as a destination. Further, at the adjustment unit 126, the DA that is the destination MAC address of a stored frame is rewritten to be the MAC address of the first router 112 (as shown in FIG. 18, because after a relayed packet is once transferred to a router (S2002) it is then transferred to the server 113 (S2003)), and the SA that is the sender MAC address is rewritten to be its own MAC address. A frame transmitted from the PC 111 stored in the adjustment unit 126 is selectively multiplexed by the selection unit 128 as described above using FIG. 6. At this time, priority is given to selectively transmitting a frame transmitted from the IP telephony application of the first IP telephone 114, if any; therefore, priority is given to a transmitted frame (voice data) by the first IP telephone 114 itself over a frame transmitted from the PC 111.

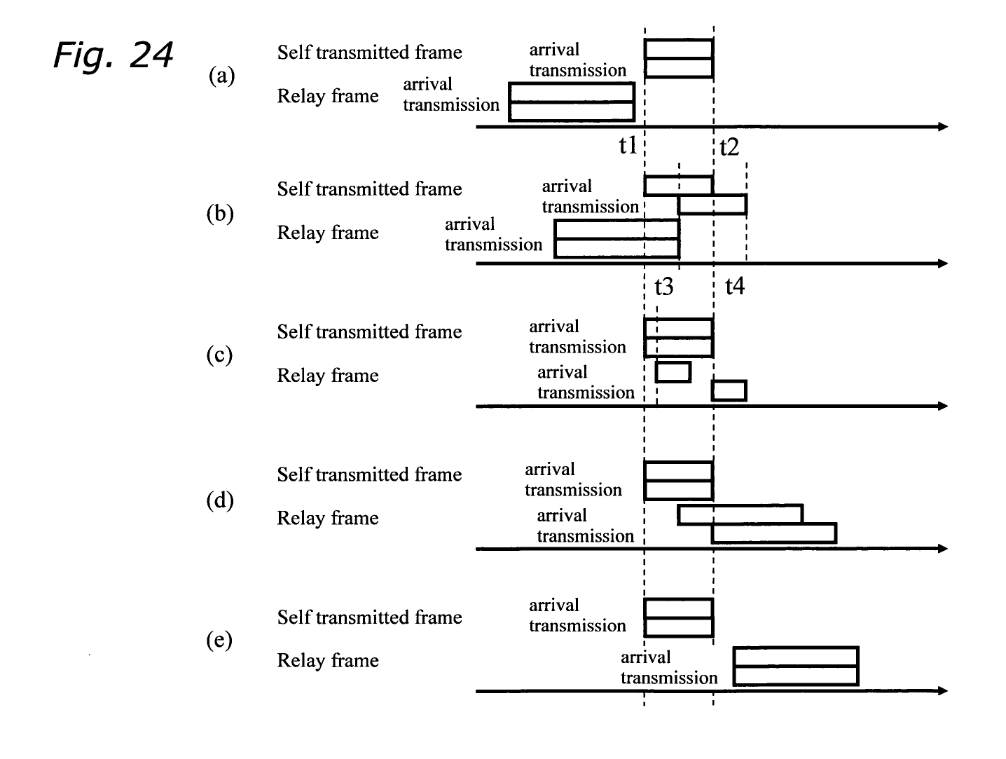

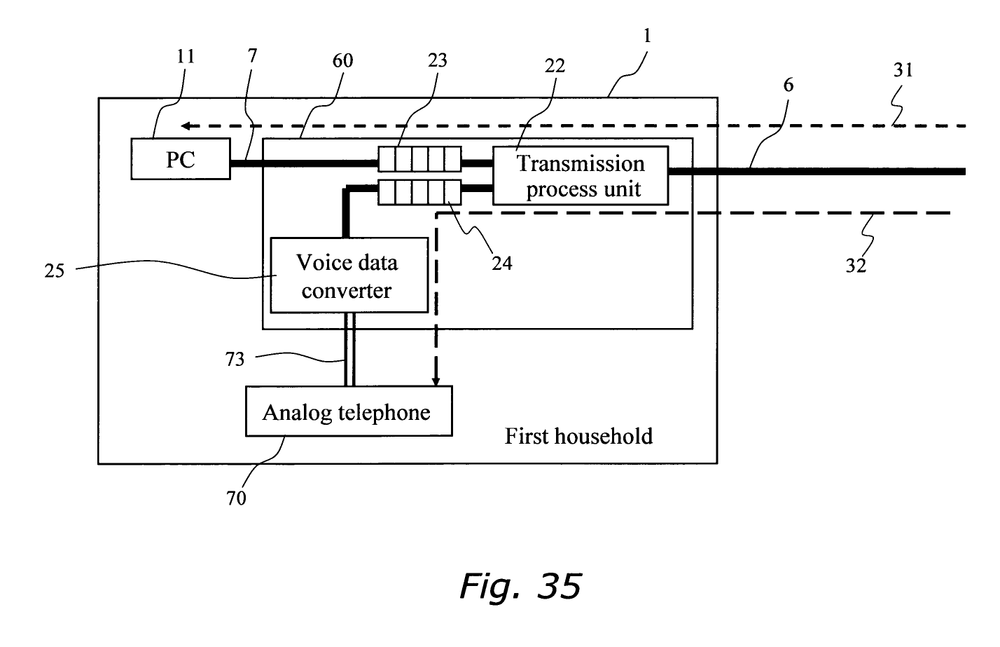

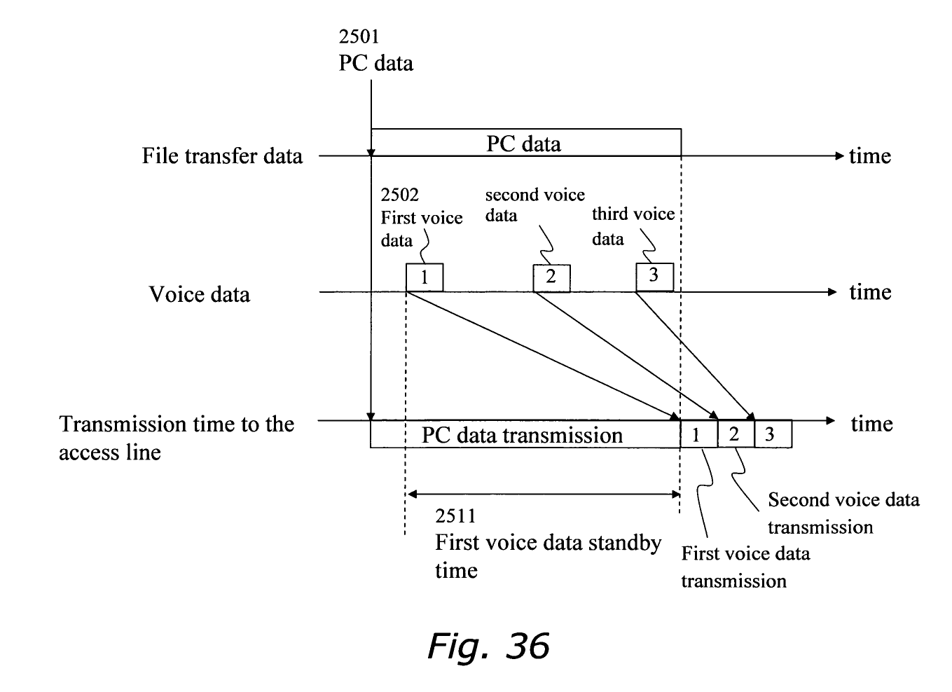

FIGS. 24, 35 and 36 shows the relationship between arrival (transmission request) and transmission (read) by the selection unit of a transmission frame (self transmitted frame) from the first IP telephone 114 and a relay frame received from the PC 111. These figures explain detailed operations of the transmission/reception and relay process (which differ depending on whether the adjustment unit 126 comprises a buffer, and whether the LAN line 107 is full or half duplex) explained above.

First, FIG. 24 shows a case where the adjustment unit 126 comprises a buffer and the LAN line 107 is full duplex.

In the case of (a) and (e): If there is no self transmitted frame at time of relay frame arrival, and if there is no self transmitted frame at time of relay frame transmission completion, the relay continues as-is.

In the case of (b): If there was no self transmitted frame at time of relay frame arrival, but there is a self transmitted frame transmission request at time of relay frame transmission, when relay frame transmission is completed at time t3, even if there is a subsequent relay frame transmission request from the adjustment unit 126, the self transmitted frame is transmitted immediately, and the transmission is completed at time t4.

In the case of (c) and (d): If during transmission of a self transmitted frame, a relay frame arrives, upon completion of the self transmitted frame transmission (time t2), transmission of the relay frame commences. Because the buffer size of the adjustment unit 126 is assumed to be large enough to store the frame, the relay frame can be made to stand by during the transmission of the self transmitted frame.

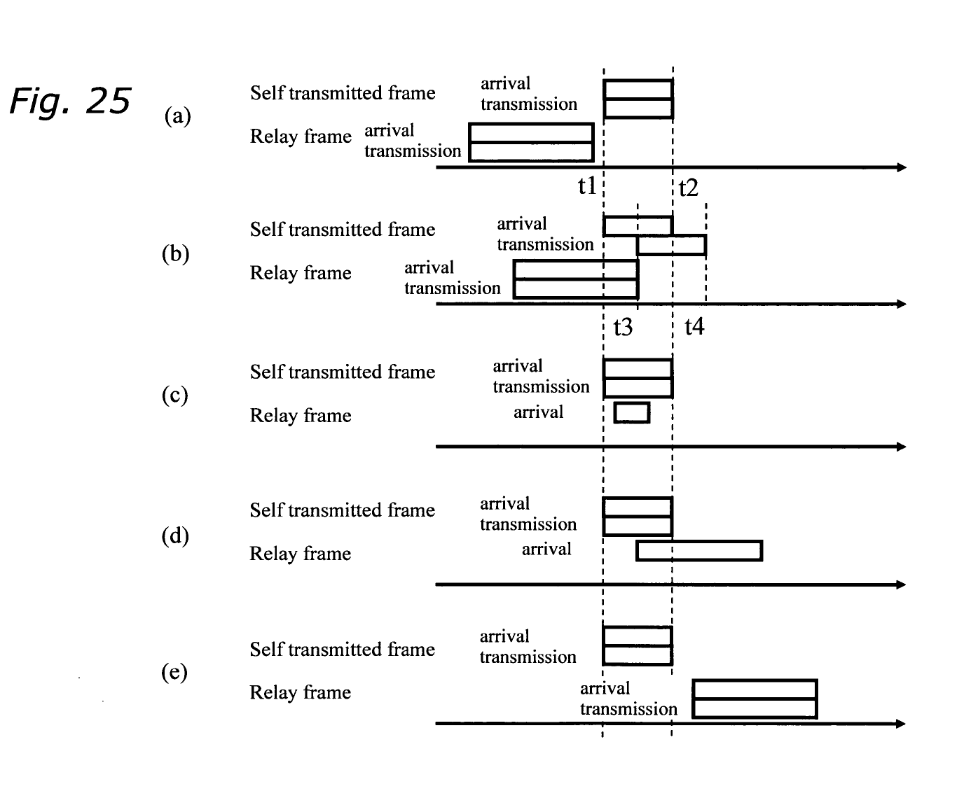

On the other hand, when the buffer size of the adjustment unit 126 is small, for example, the size of an elastic stick memory, as shown in FIG. 25, when a relay frame arrives during the transmission of the self transmitted frame (FIGS. 8(c) (d)), the relay frame is discarded.

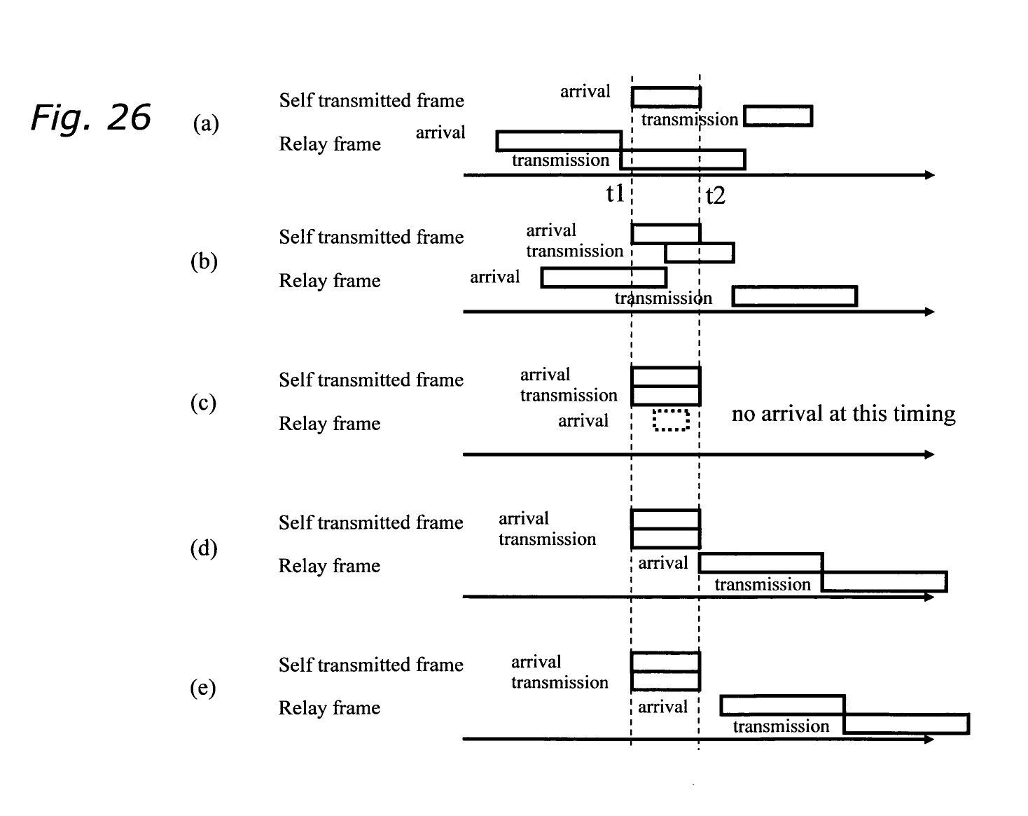

Further, when the buffer of the adjustment unit 126 has sufficient capacity to store the frame, and the transmission channel is half duplex, the transmission timing is as shown in FIG. 26. In other words, because of the half duplex transmission channel, transmission cannot be made during reception.

In the case of (a): A self transmitted frame cannot be transmitted until the relay frame transmission is completed.

In the case of (b): While relay frame arrival has been completed, because there is a self transmitted frame, the relay frame is transmitted after the self transmitted frame transmission has ended.

In the case of (c): Because the self transmitted frame transmission is under way, a relay frame cannot be received at the corresponding timing. The relay frame arrives at the timing (d).

In the case of (d) and (e): Because there is no self transmitted frame when the relay frame arrives, transmission is performed upon completion of relay frame reception.

In the above explanation, the selection unit 128 transmits communication data 2062 for a lower priority communication only when there is no higher priority communication transmission request from the TCP/IP process unit 124. Alternatively, regardless of whether there is higher priority communication data, after a certain period of time, transmission data of the lower priority communication device may be extracted from the buffer and output to the network at any time. Thus, by outputting the lower priority communication to the network at any time after a certain period of time, control for securing the QoS of a higher priority communication is performed regardless of whether there is a higher priority communication.

<Detailed Control After Path Change>

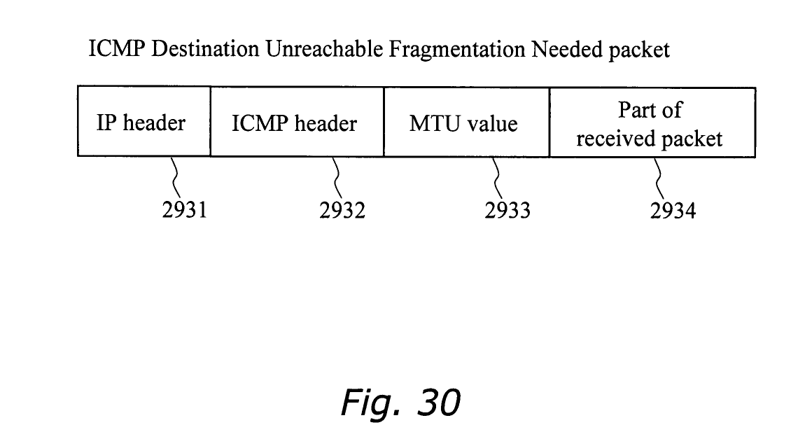

Explanation has been made heretofore for cases where the detailed control performed by the first IP telephone 114 having the QoS control unit 121 of the present invention is priority control as performed by a dedicated router in FIG. 30. Alternatively, any other generally well known priority control methods may be used.

However, such priority control between a higher priority communication and lower priority communication was possible because in FIG. 16, the present invention is configured as a functional part of the first IP telephone 114 as the device at which the higher priority communication terminates. When the telephone 114 is not same as the device at which the higher priority communication terminates, for example, when it is at the position 1583 in FIG. 9, after any of the various path change methods described above is used to change the communication path for higher priority communication so as to be routed through the first IP telephone 114, priority control between a higher priority communication and lower priority communication may be performed by the selection unit 128. The communication paths of the higher priority communication and lower priority communication at this time are, respectively, an IP telephone-IP telephone communication 1531 after path change in FIG. 9 and PC-server communication 133 after path change. Further, in this case, as priority information for distinguishing the lower priority communication from higher priority communication, the selection unit 128 needs to deliver, from the priority information holding unit 841 to the selection unit 125, information such as an IP address, transport layer protocol (TCP and UDP), port number and the like that characterize the lower priority communication or higher priority communication data (S1953). Such information contained in the priority information holding unit 841 may be default values, or information input from user interface or acquired by some unit using the network.

Further, there are detailed controls that can be performed without changing communication path for higher priority communication even by a communication device of the present invention, for example, the above first IP telephone 114, that is not the device at which a higher priority communication terminates. In such cases, instead of delivering a lower priority communication received from the analysis unit 127 directly to the selection unit 128, the adjustment unit 126 operates so as to deliver to the selection unit data once delivered to the adjustment unit 126 and returned therefrom. Further, in such cases, the selection unit 128 may transmit the received data in order, without performing priority control.

Some examples of detailed control in such cases will be described, some of which are processed by the adjustment unit 126.

1. The adjustment unit 126 of the communication device of the present invention discards some or all of lower priority communication packet.

2. In a case where a lower priority communication uses TCP (Transmission Control Protocol), the adjustment unit 126 of the communication device of the present invention rewrites the window field value in the TCP header to a smaller value and transfers the same to the original packet destination. Upon receiving this packet, the device that is the original destination performs a general TCP flow, thereby lowering subsequent data transmission rate (window size). With the above described constitution, the device that is the destination controls the transmission rate of the data transmitted to the lower priority communication device. Alternatively, data for controlling the transmission rate from the lower priority communication device to the other party communication device may be generated and transmitted to the lower priority communication device.

3. In a case where a lower priority communication uses TCP (Transmission Control Protocol), the adjustment unit 126 of the communication device of the present invention generates one or more Ack (Acknowledgement: receipt confirmation response) packets having a sequence number contained in the TCP header of the Ack packet and transfers the same to the original packet destination. Upon receipt of the plurality of Ack packets, due to TCP flow control, the subsequent data transmission rate (window size) of the device that is the original destination is lowered.

4. In a case where a lower priority communication uses TCP (Transmission Control Protocol), the adjustment unit 126 of the present invention causes a delay for a certain period of time from reception to transfer to the original destination. At this time, because the timing of transmission of subsequent packets is also delayed by TCP flow control, the subsequent data transmission rate is lowered.

5. The path change control unit 842 of the communication device of the present invention may further comprise a QoS value maintaining unit (not shown in the drawings) for maintaining the QoS value set for maintaining higher priority communication quality. The path change control unit 842 further calculates a value indicating the higher priority communication quality based on the communication traffic amount, and compares the calculated value for indicating the quality with the QoS value. If the calculated value for indicating quality is smaller than the QoS value, path change control data is transmitted. Therefore, the communication path of lower priority communication is changed in accordance with the degradation of the higher priority communication quality, thereby securing the communication path of the higher priority communication during the necessary period of time only, and eliminating the influence on the lower priority communication during the other time. The value for indicating the higher priority communication quality can be obtained from, in addition to traffic amount, applications used for telephony, a value for indicating a voice quality, and the like.

<Packet Size Change Control>

With the detailed control after the path change, in addition to the priority control described above the packet size of a lower priority communication can be reduced, thereby further improving the QoS of the IP telephony communication.

An explanation has already been made for the phenomenon of the QoS of the IP telephony communication degrading when the packet size of lower priority communication is large, in phenomenon 4 in the Background Art, and thus such explanation will be omitted here.

Methods for reducing the packet size of a lower priority communication can be roughly classified into (1) methods for dividing and transmitting lower priority communication packets received by the QoS controller, and (2) methods for causing the lower priority communication device (e.g. PC 111 etc.) to reduce the size of packets it transmits itself. An explanation will be given for each method with some examples.

(1) Method for Causing the Adjustment Unit 126 to Divide (Fragment) and Transmit Lower Priority Communication Packets Received by the QoS Controller

The easiest method for dividing and transmitting lower priority communication packets received by the QoS controller is to perform IP fragmentation. IP fragmentation using an ordinary router involves, when the size of packets transferred by the router exceeds the MTU (Maximum Transfer Unit) of the access line, dividing a packet into a plurality of packets with a size no greater than the MTU. However, in this case, regardless of the MTU value of the access line, a packet, for example, of 1500 bytes (the 20 bytes of IP header are subtracted from the IP data size, resulting in 1480 bytes) is divided into a plurality of packets of 300 bytes (IP data size is 280 bytes). With such a constitution, the time spent for transmitting a fragmented packet to the access line (the maximum time the voice data has to stand-by in the router) is 300/1500, or one-fifth. Therefore, greater delay and jitter of the IP telephony communication can be prevented.

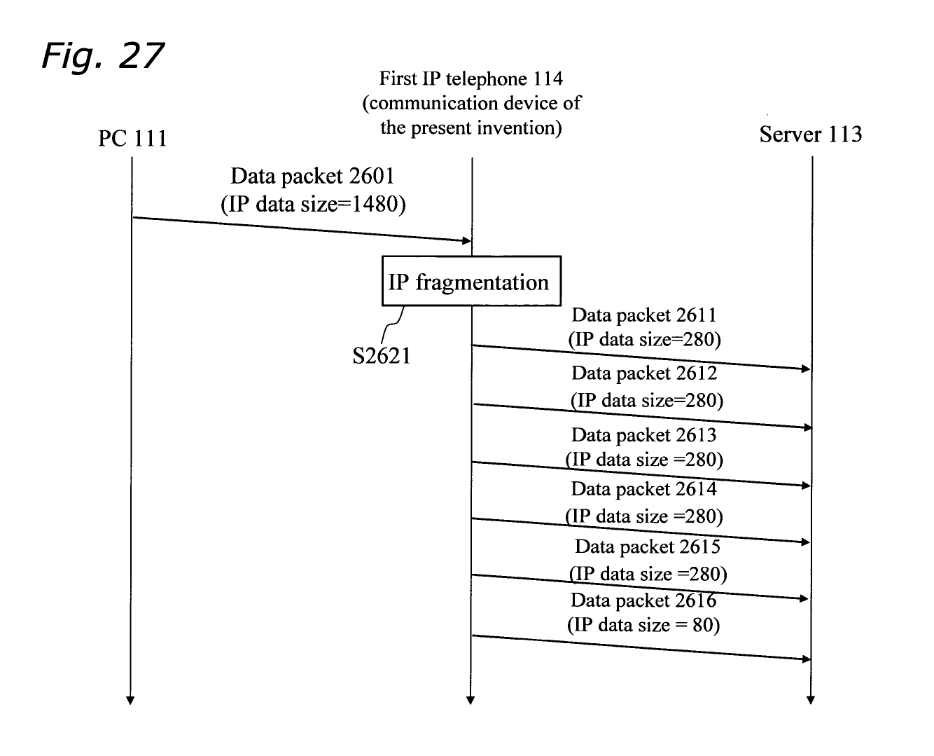

A brief explanation will be given with reference to FIG. 27 for packet flow when there is IP fragmentation. First, the PC 111 transmits the data packet 2601 of 1500 bytes as usual. As described above, the communication path destination of the PC 111 that is a lower priority communication has been changed to the first IP telephone 114 that is a higher priority communication. The QoS control unit 121 of the first IP telephone 114 of the present invention, having received the data packet 2601 from the PC 111, first performs IP fragmentation. Then, the QoS control unit 121 transmits the plurality of divided data packets 2611-2616 to the server 113. In the fragmented data packets 2611-2616, as in standard IP fragmentation, a value indicating the positional relationship of the data packets in the original data packet 2601 is set in the fragmentation offset field of the IP header. More specifically, a value is set indicating which position, counting from the front of the original data packet 2601, the front of data contained in each data packet occupies. Further, in packet fragments other than the last packet fragment 2616, a more packet fragment flag is set indicating the existence of subsequent packet fragments.

In the present invention any method for dividing data can be used, and such method is not limited to IP fragmentation. For example, alternative methods to division by IP fragmentation include extracting a TCP data stream from a series of IP packets and dividing the data again into a suitable size and transmitting the same as IP packets, and dividing an IP packet in the data link layer into a plurality of data strings (for Ethernet®, this method cannot be employed for reasons of protocol, but in the future when a data link protocol compatible with such a method is refined, such a method will be employed).

If a no fragmentation bit is set in an IP header, according to IP fragmentation stipulated under IPv6, fragmentation by a relay device is not allowed. However, it is possible to continue normal communication while performing IP fragmentation against such rules, and the present invention includes cases where IP fragmentation is performed with respect to such packets.

(2) Method for Reducing the Size of a Packet Transmitted by a Sender Device of a Lower Priority Communication

Examples of a method for reducing packet size at time of transmission by a sender of the lower priority communication include changing the MSS (Maximum Segment Size) contained in a TCP SYN packet, and changing the MTU (Maximum Transfer Unit) of a lower priority communication device using an ICMP Destination Unreachable Fragmentation Needed packet. However, the present invention is not limited to these methods.

(2-1) MSS Change

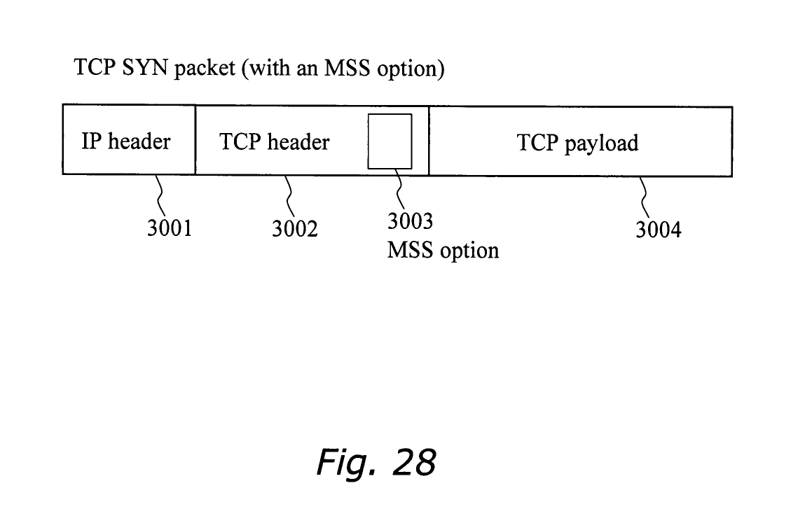

An explanation will be made for a method for changing the MSS of an SYN packet. FIG. 28 shows the format of a TCP SYN packet with an MSS option. The MSS is a value stipulated by TCP, representing the maximum data size at time of dividing data. The MSS is a value stipulated for storing data received from an application in each IP packet. The MSS is determined as follows. First, SYN packets are transmitted from both devices at time of starting a TCP session, and values in the MSS field in the SYN packets are compared. Then, the smaller MSS is selected, thereby determining MSS.

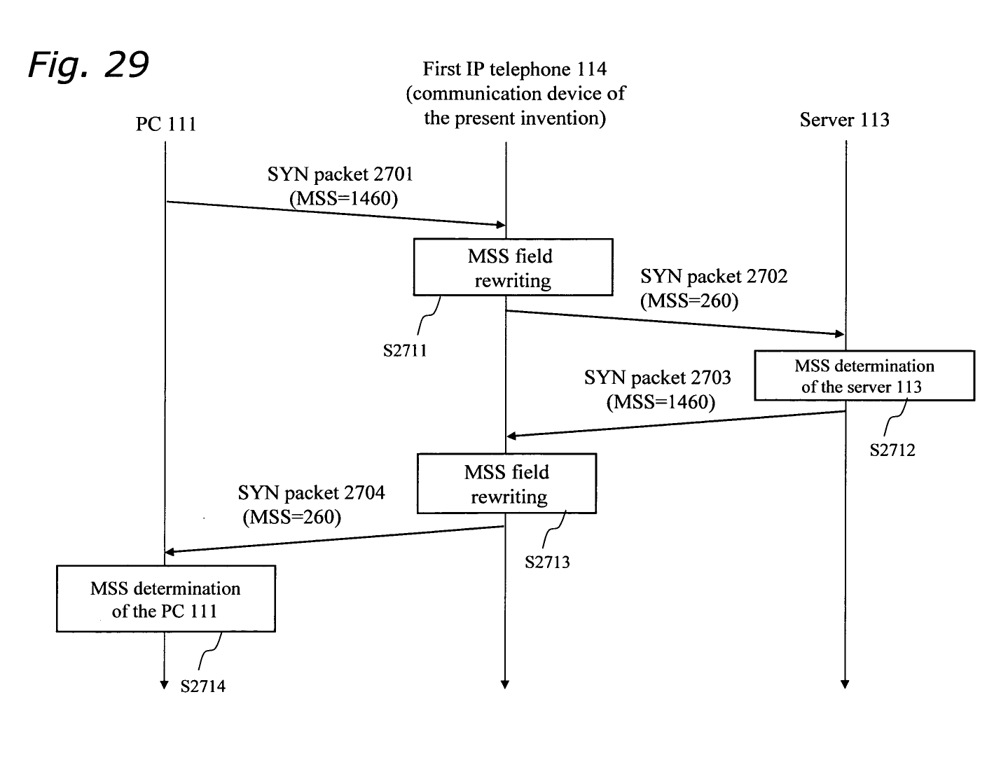

An explanation will be given with reference to FIG. 29 for a method of using this mechanism to reduce the size of a packet transmitted by a sender device of a lower priority communication. As described above, the destination of a communication path of the PC 111 that is a lower priority communication is changed to the first IP telephone 114 that is a higher priority communication.

First, the PC 111 transmits a SYN packet 2701 to the server 113 when starting a TCP session. At this time, the PC 111 sets the value in the MSS field at 1460 (this value, obtained by subtracting the 20 bytes of the IP header and 20 bytes of the TCP header from the 1500 byte Ethernet MTC size, is often used).

With the path change thus performed, the first IP telephone 114 receives the SYN packet transmitted by the PC 111 to the server 113. The adjustment unit 126 in the QoS control unit of the first IP telephone 114 changes the value in the MSS field of the SYN packet into a smaller value, for example, 260, and transfers the same to the server 113 (S2711). The QoS control unit at this time also needs to revise the checksum field in the TCP header.

Next, the server 113 compares the value 260 in the MSS field of the received SYN packet with the MSS value set in the SYN packet it is to transmit itself (here, 1460). The server 113 sets the smaller value of 260 as the MSS value of the server 113 (S2712).

Next, the server 113 transmits the SYN packet to the PC 111. At this time, the server 113 sets the value in the MSS field at 1460. Because the path change is thus performed, the first IP telephone 114 receives the SYN packet from the server 113. The adjustment unit 126 of the first IP telephone 114 changes the value in the MSS field of the received SYN packet into a smaller value, for example, 260, and transfers the same to the PC 111 (S2713). At this time as well, the checksum field in the TCP header also needs to be revised.

Next, the PC 111, having received the same, compares the value 260 in the MSS field of the received SYN packet with 1460, which is the MSS value set in the SYN packet that it itself is to transmit. Then, the smaller value 260 is set as the MSS value of the PC 111 (S2714). Thereafter, the size of the TCP packet transmitted by the PC 111 and server 113 is 300 bytes (TCP data 260 bytes+TCP header 20 bytes+IP header 20 bytes).

Here, it was assumed that the MSS field of the SYN packets to be transmitted by both devices are rewritten. If the size of only the packet to be transmitted by the PC 111 is to be reduced, S2711 is skipped and only S2713 is performed. Further, skipping S2713 and performing only S2711 enables the size of a packet transmitted from the server 113 to be reduced.

(2-2) MTU Change

An explanation will be given of a method for using an ICMP Destination Unreachable Fragmentation Needed packet (see FIG. 30). In this method, notification is given to a device of the need to divide and fragment packets, and the device is caused to set the packet size according to the notice.

FIG. 30 shows the format of an ICMP Destination Unreachable Fragmentation Needed packet. As the MTU value set in each communication device, the maximum transmission data size stipulated in the data link layer protocol used by the transmission line is usually set. However, if an ICMP Destination Unreachable Fragmentation Needed packet is received by a communication device, for example, the PC 111, the MTU value set in the packet transmitted by the PC 111 is overwritten by the MTU value contained in the MTU field thereof (2933). If the MTU value of the communication device is changed, the size of subsequent IP packet transmitted by the communication device is less or equal the post-change MTU value.

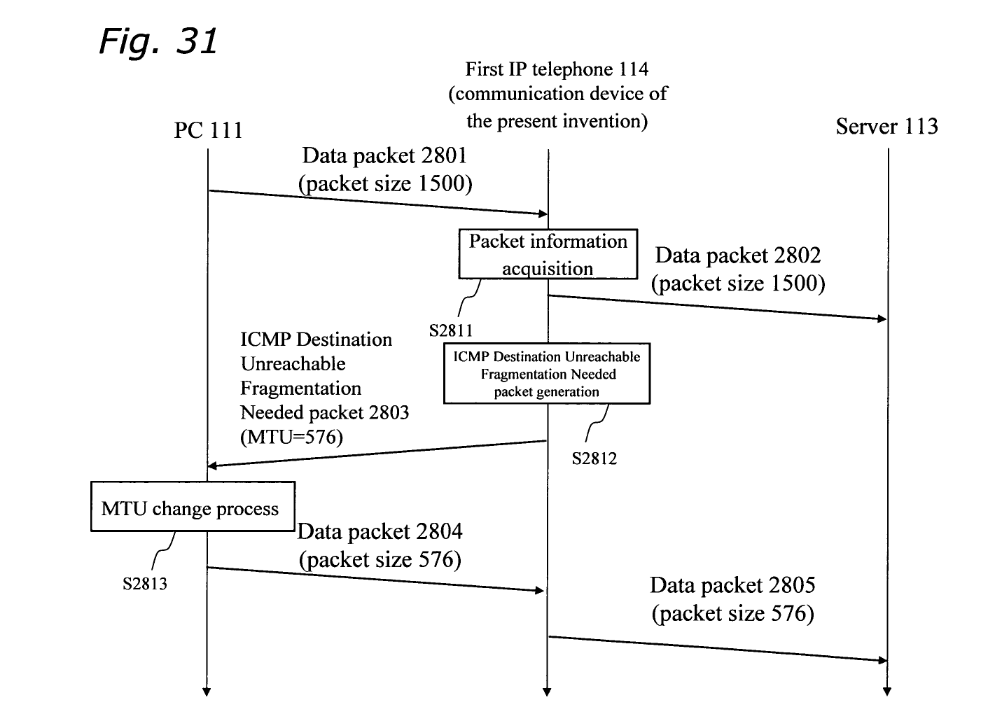

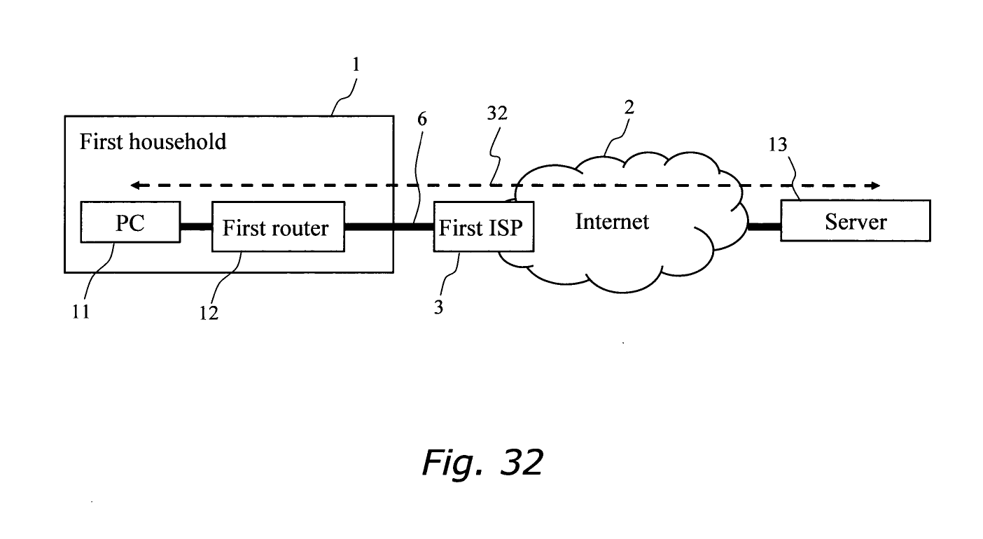

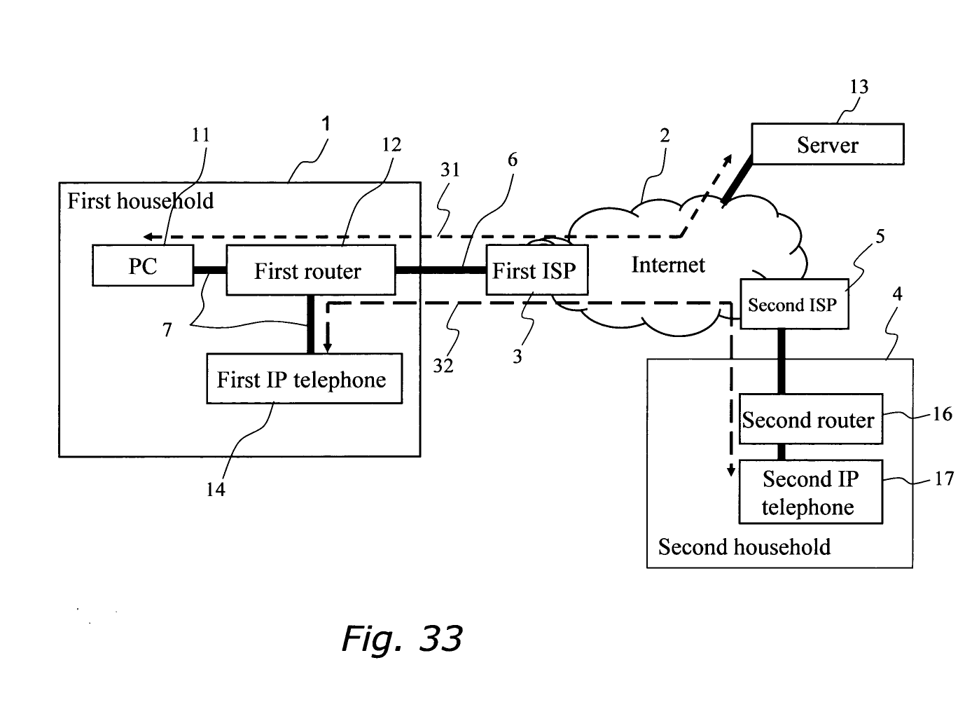

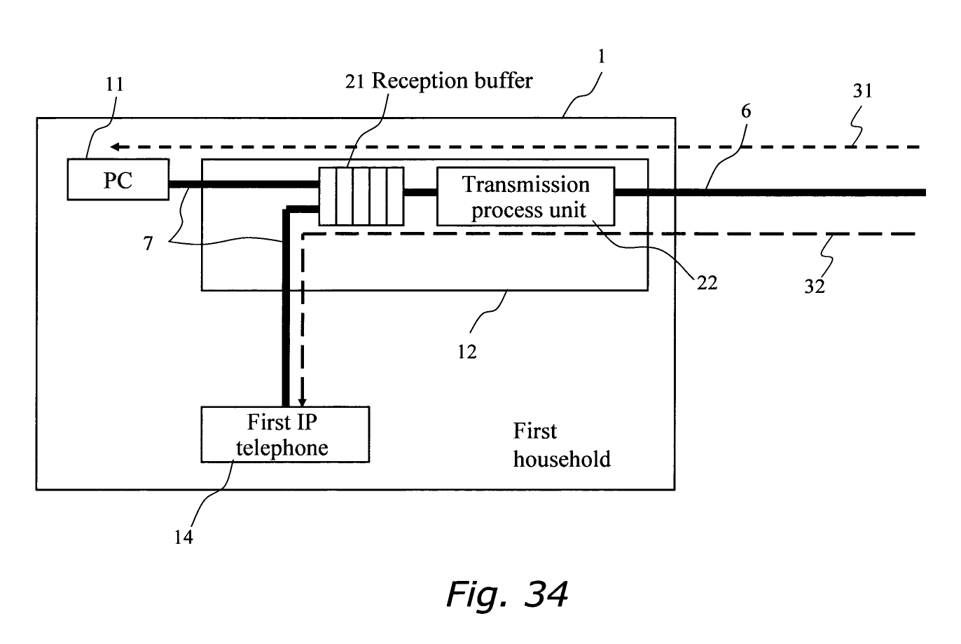

An explanation will be made with reference to FIGS. 30 and 31 for the process of using the ICMP Destination Unreachable Fragmentation Needed packet to reduce the MTU of a lower priority communication device. First, the PC 111 transmits a data packet 2801 of 1500 bytes in accordance with the normal MTU value 1500. When the path is changed as described above, the first IP telephone 114 of the present invention receives this packet from the PC 111. The adjustment unit 126 of the QoS control unit of the first IP telephone 114 obtains information for setting a part of the ICMP Destination Unreachable Fragmentation Needed packet in FIG. 30 at 2934 (data of a minimum of 64 bytes from the head of the received packet) (S2811). The received data is transferred as is to the server 113 as a data packet 2802.

Next, the adjustment unit 126 of the QoS control unit of the first IP telephone 114 generates an ICMP Destination Unreachable Fragmentation Needed packet 2803 and transmits the same to the PC 111 (S2812). The IP address of the first router 112 is set as the sender IP address of the IP header 2931 in this ICMP Destination Unreachable Fragmentation Needed packet, and the IP address of the PC 111 is set as the destination IP address. Further, in the ICMP header 2932, a default value is set for indicating that this packet is a Destination Unreachable Fragmentation Needed packet. Further, as an MTU value, for example, “576” is set as the size of a packet to be transmitted by a lower priority communication device. Further, in a part 2934 of the received packet, information of the received packet obtained in S2811 can be set.

Next, the PC 111, having received the ICMP Destination Unreachable Fragmentation Needed packet 2803, changes its own MTU value to the designated 576 (S2813). Thereafter, the size of data packets 2804 transmitted by the PC 111 becomes 576 bytes at maximum. Thus, the size of data packet of the PC 111 transferred by the first IP telephone is reduced, improving the QoS of the IP telephony communication.

Here, 576 was designated as the MTU value. Alternatively, any value can be used as long as the size enables the QoS of the IP telephony communication to be secured. However, depending on the lower priority communication device used, there are many cases where an MTU value will not be changed even when an ICMP Destination Unreachable Fragmentation Needed packet having an MTU value of less than 576 is received; therefore, a designation of at least 576 more reliably ensures that the effects will be demonstrated.

Further, description was made above for a method for using an ICMP Destination Unreachable Fragmentation Needed packet used in an IPv4 network. However, in the case of an IPv6 network, an oversized ICMPv6 packet has an identical function; therefore, the MTU of a lower priority communication device can be changed by using such a packet. Further, designating an MTU option in an ICMPv6 Router Advertisement packet also achieves similar effects.

Further, it is assumed that, for example, a packet is transmitted with a no fragmentation flag for preventing the PCT 111 from dividing a packet. In this case, the first IP telephone 114 that received this packet is prevented from dividing the received packet due to the no fragmentation flag. However, as described above, the first IP telephone 114 transmits an ICMP Destination Unreachable Fragmentation Needed packet to change the MTU value in the PC 111. Therefore, even when the received packet is prevented from being divided, the device that received a packet is capable of reducing packet size. Further, because the MSS change in 2-1 above is performed by changing the MSS option in the TCP header, this cannot be used for UDP. However, the method for changing an MTU value in 2-2 above can be applied to both TCP and UDP.

<Other>

<Applicable Environment>, <Installation Position>, <Path Change Method> and <Path Change Timing> are identical to those of the first embodiment, and a description thereof is thus omitted.

By using a communication device of the present invention that performs the above operations, a lower priority communication and higher priority communication compete with each other. However, in a network in which priority control is not performed, a priority control function can be realized without changing routers, allowing a user to easily enjoy real-time communications such as IP telephony without changing providers.

The communication device of the present invention further comprises a transmission data generator for generating transmission data to be transmitted to the other party communication device, and if the transmission data is higher priority communication data, the selection unit may be configured so as to give priority to transmitting such transmission data. With such a constitution, if the communication device itself transmits the higher priority transmission data to other communication devices, transmission can be performed so as to give priority to its own higher priority transmission data over lower priority communication data that requires relay. Further, the above selection unit may be configured so as to give priority to transmitting higher priority communication data from among the plurality of received data. With such a constitution, the communication device receives a plurality of received data from a plurality of communication devices, and if there is a need for relay to other communication devices, priority is given to transmitting the highest priority received data from among such received data.

### Other Embodiments

Each embodiment explained for the present invention can be realized by causing a CPU to execute a program for causing the CPU to execute the above processes. In this case, such program may be stored on a recording medium and executed from a memory device (hard disk and the like) on which such contents have been stored, or may be executed directly from the recording medium. The recording media in this case include semiconductor memories such as ROMs, RAMs and flash memories, magnetic disk memories such as flexible disks and hard disks, optical disks such as CD-ROMs, DVDs and BDs, and recording media such as memory cards and the like.

Further, the function of the QoS control unit explained in each embodiment may be realized using a large-scale integrated circuit. Due to differences in degree of integration, this may be called an IC, system LSI, super LSI, or ultra LSI.

Further, unit for circuit integration is not limited to an LSI circuit, and may be realized using a dedicated circuit or general processor. After manufacturing an LSI circuit, programmable FPGA (Field Programmable Gate Array), or a reconfigurable processor capable of reconfiguring the connection and settings of a circuit cell in the LSI may be employed.

### INDUSTRIAL APPLICABILITY

The communication device of the present invention is applicable to general networks in which a lower priority communication and higher priority communication compete with each other, but priority control is not performed. It is also applicable to a case where a plurality of communications compete with one another, for example, an access line (ADSL line etc.) in a household Internet connection environment, and a slow speed communication path (between wireless zones, electric light line and the like) in a household LAN and corporate LAN.

1. A communication device that performs communications via a network in which a plurality of communications with different priority ranking are performed and that controls communications in accordance with the priority rankings, comprising:
a priority information holding unit for holding priority information with respect to the priority ranking of each communication; and
a path change control unit for generating, based on the priority information, first control data for changing a communication path for lower priority communication, and transmitting the first control data to a lower priority communication device performing the lower priority communication, or to a relay device relaying a lower priority communication performed between other communication devices via the network.

2. A communication device according to claim 1, wherein the path change control unit changes a destination of the communication path for the lower priority communication in the first control data to an undeliverable address.

3. A communication device according to claim 1, wherein the path change control unit changes a destination of the communication path for the lower priority communication in the first control data to an address of the communication device that controls communications in accordance with priority ranking, and further comprises
a communication control unit for controlling output of data transmitted from the lower priority communication device to the network.

4. A communication device according to claim 3, wherein the communication control unit further comprises:
an analysis unit for analyzing whether its own device is the destination for at least one received data and whether the received data is lower priority communication data from the lower priority device; and
a selection unit for controlling such that, in accordance with the results of analysis by the analysis unit, higher priority communication data is selected over lower priority communication data, the destination of which is a device other than its own device and is transmitted to its destination.

5. A communication device according to claim 4, wherein the communication control unit further comprises:
an adjustment unit for preforming an address rewriting process that, in accordance with the results of analysis by the analysis unit, rewrites the sender address of lower priority communication data for which the destination is a device other than its own device to the address of its own device, and rewrites the destination address of the lower priority communication data to the original destination address of the lower priority communication data transmitted from the lower priority communication device prior to the path change, and
the adjustment unit transmits the lower priority communication data after the address rewriting process to the selection unit.

6. A communication device according to claim 4, further comprising:
a higher layer process unit that processes received data addressed to its own device in accordance with the results of analysis by the analysis unit, wherein
the analysis unit determines whether the received data is addressed to its own device by analyzing the IP header of the received data and determining whether the IP address is of its own device, and if the received data is addressed to its own device, transmits the received data to the higher layer process unit; and if the destination is a device other than its own device, transmits the received data to the selection unit.

7. A communication device according to claim 3, wherein the communication control unit is constituted by hardware.

8. A communication device according to claim 4, wherein the communication control unit further comprises:
an adjustment unit for discarding the lower priority communication data in whole or in part, and
the adjustment unit transmits to the selection unit the lower priority communication data after it has been discarded in whole or in part.

9. A communication device according to claim 4, wherein the communication control unit further comprises:
an adjustment unit for performing a first adjustment process to adjust a communication rate of the lower priority communication, and the adjustment unit transmits to the selection unit the lower priority communication data after the first adjustment process.

10. A communication device according to claim 9, wherein the adjustment unit adjusts a transmission rate by adjusting a value in a window field of a TCP header.

11. A communication device according to claim 9, further comprising a storage unit for storing the lower priority communication data, and if the lower priority communication data is TCP data packets or TCP ACK packets, the adjustment unit stores the lower priority communication data for a certain period of time using storage unit, and thereafter transmits the same to the selection unit.

12. A communication device according to claim 4, wherein the communication control unit further comprises:
an adjustment unit for dividing data transmitted from the lower priority communication device into a plurality of data using a first dividing method, and
the adjustment unit transmits the plurality of data divided using the first dividing method to the selection unit.

13. A communication device according to claim 12, wherein the first dividing method makes division into IP fragments.

14. A communication device according to claim 4, wherein the communication control unit further comprises:
adjustment unit for generating, based on communication data received from the lower priority communication device, third control data for controlling the size of communication data from the lower priority communication device to its counterparty communication device or of communication data to the lower priority communication device from its counterparty communication device, and transmitting the same to the lower priority communication device or the communication device of its counterparty.

15. A communication device according to claim 14, wherein the third control data is a TCP SYN packet, and the adjustment unit generates a SYN packet by changing the MSS value contained in the received SYN packet to a desired value.

16. A communication device according to claim 14, wherein the third control data is ICMP Destination Unreachable Fragmentation Needed packets, and the adjustment unit generates ICMP Destination Unreachable Fragmentation Needed packets that contain a portion of the data contained in packets previously transmitted from the lower priority communication device and contain a desired MTU value.

17. A communication device according to claim 1, wherein the path change control unit changes, in the first control data, the destination of the communication path for lower priority communication to the address of its own device, and generates second control data for changing the communication path for higher priority communication based on the priority information, and changes the destination for the communication path for higher priority communication in the second control data to the address of its own device, and then transmits the second control data to the higher priority communication device.

18. A communication device according to claim 1, wherein the first control data transmitted by the path change control unit is any one of an ARP request packet, ARP response packet, ICMP redirect packet or ICMPv6 Neighbor Discovery packet.

19. A communication device according to claim 1, further comprising:
a detection unit for detecting whether a communication is being performed by the higher priority communication device via a network, and
only when communication is being performed by the higher priority communication device, the path change control unit transmits the first control data to the lower priority communication device or the relay device.

20. A communication device according to claim 19 further comprising:
a QoS value maintaining unit for maintaining a QoS value set for maintaining the quality of higher priority communication, wherein
the detection unit further calculates a value for indicating the quality of a higher priority communication and compares the calculated value for indicating the quality with the QoS value, and
if the calculated value for indicating the quality is smaller than the QoS value, the path change control unit transmits the first control data to the lower priority communication device or the relay device.

21. A computer readable recording medium having recorded thereon a priority control program to be executed by a control device that controls communications of a plurality of communications with different priority ranking performed via a network in accordance with the priority rankings so as to cause a computer to function as:
a priority information holding unit for holding priority information with respect to the priority ranking of each communication; and
a path change control unit for generating, based on the priority information, first control data for changing a communication path for lower priority communication, and transmitting the first control data to a lower priority communication device performing the lower priority communication, or a relay device relaying lower priority communication performed between other communication devices via the network.

22. An integrated circuit that controls communications in a network in which a plurality of communications with different priority ranking are performed in accordance with the priority rankings, comprising:
a priority information holding unit for holding priority information with respect to the priority ranking of each communication; and
a path change control unit for generating, based on the priority information, first control data for changing communication path for lower priority communication, and transmitting the first control data to a lower priority communication device performing the lower priority communication, or a relay device relaying a lower priority communication performed between other communication devices via the network.

23. A communication system in which a communication device that controls communications in accordance with priority ranking of communications is connected to a plurality of communication devices with different priority ranking, wherein
the communication device that controls communications in accordance with priority ranking includes:
a priority information holding unit for holding priority information with respect to the priority ranking of each communication; and
a path change control unit for generating, based on the priority information, first control data for changing a communication path for lower priority communication having lower priority, and transmitting the first control data to a lower priority communication device performing the lower priority communication, or a relay device for relaying a lower priority communication performed between other communication devices via the network; and
the lower priority communication device or the relay device relaying lower priority communications with other communication devices performed via the network receives the first control data from the communication device that controls communications in accordance with the priority ranking to change the communication path for lower priority communication.
